(19) United States
(12) Patent Application Publication
(10) Pub. No.: US 2014/0111748 A1
(43) Pub. Date: Apr. 24, 2014

(54) DISPLAY DEVICE

(71) Applicants: Kozo Nakamura, Osaka-shi (JP); Satoru Kishimoto, Osaka-shi (JP)

(72) Inventors: Kozo Nakamura, Osaka-shi (JP); Satoru Kishimoto, Osaka-shi (JP)

(21) Appl. No.: 14/123,804

(22) PCT Filed: May 31, 2012
(86) PCT No.: PCT/JP2012/064082

§ 371 Date: Dec. 4, 2013

(30) Foreign Application Priority Data
Jun. 7, 2011 (JP) 2011-127603

(51) Int. Cl. G02F 1/1335

(52) U.S. Cl. CPC G02F 1/133514
USPC 349/108

(57) ABSTRACT

The present invention provides a display device capable of presenting a display with a large color reproduction range and displaying bright red. A display device according to the present invention forms an image by using red, green, blue, and yellow pixels, and includes a light source. Light emitted from the light source has a red peak wavelength of 615 nm or more and 650 nm or less. A half-width of the red peak is 15 nm or more and 70 nm or less when the peak wavelength is 615 nm or more and 635 nm or less, 40 nm or more and 93 nm or less when the peak wavelength is more than 635 nm and 640 nm or less, and 57 nm or more and 93 nm or less when the peak wavelength is more than 640 nm and 650 nm or less.

### TECHNICAL FIELD

The present invention relates to display devices. More specifically, the present invention relates to a display device suitable for use as a liquid-crystal display device that forms an image by using red, green, blue, and yellow pixels.

### BACKGROUND ART

Various displays that form images with pixels are in widespread use as display devices that provide means for displaying information and pictures. In particular, display panels, such as liquid crystal display panels and organic electroluminescence (EL) display panels, in which each pixel includes a plurality of sub-pixels of respective primary colors to achieve color display are generally used.

A general display device forms an image with pixels of three colors for displaying red, green, and blue, which are three primary colors of light, to achieve color display. To increase a displayable color range (color reproduction range), a multiple-primary-color display device has been proposed in which yellow sub-pixels are provided in addition to the red, green, and blue sub-pixels. The yellow sub-pixels have a color filter with a high transmittance. With this display device, since the yellow sub-pixels having a color filter with a high transmittance are additionally provided, reduction in the brightness of white display can be suppressed. In addition, since the number of primary colors used for display is increased, the color reproduction range can be increased.

For example, a display device is disclosed in which a display surface includes pixels including red, green, blue, and yellow sub-pixels and in which the red sub-pixels have the largest opening area (see, for example, PTL 1).

In recent years, new light sources for display devices, such as nano fluorescent materials and semiconductor light emitting elements, suitable for use in, for example, backlights of liquid-crystal display devices have been researched and developed (see, for example, PTL 2 and PTL 3).

### CITATION LIST

### Patent Literature

PTL 1: International Publication No. 2007/148519 Pamphlet
PTL 2: Japanese Unexamined Patent Application Publication No. 2008-19407
PTL 3: Japanese Unexamined Patent Application Publication No. 2010-141033

### SUMMARY OF INVENTION

### Technical Problem

The optical characteristics, such as brightness, of a display device that forms an image by using red, green, blue, and yellow pixels and a display device that forms an image by using red, green, and blue pixels will now be discussed in detail. For example, Table 1 shows the brightness of each display color in a four-primary-color transmissive liquid-crystal display device according to the related art which forms an image by using red, green, blue, and yellow pixels having the same opening area. Table 2 shows the brightness of each display color in a three-primary-color transmissive liquid-crystal display device according to the related art in which a display surface includes pixels including three types of pixels, which are red, green, and blue pixels having the same opening area.

TABLE 1

| Color | Red | Green | Blue | Yellow | Cyan | Magenta | White |
|---|---|---|---|---|---|---|---|
| Brightness | 11.0 | 33.4 | 7.6 | 48.0- | 43.4 | 18.6 | 100 |
| | | | | 92.4 | | | |

TABLE 2

| Color | Red | Green | Blue | Yellow | Cyan | Magenta | White |
|---|---|---|---|---|---|---|---|
| Brightness | 23.8 | 66.1 | 10.0 | 89.9 | 76.1 | 33.8 | 100 |

Tables 1 and 2 show the brightness of six colors, which are red, green, blue, yellow, cyan, and magenta, as typical display colors. The brightness of each display color corresponds to the Y value in CIE 1931 (standard) color system (XYZ color system) when the brightness of white display is 100. The transmissive liquid-crystal display devices include color filters for each pixel, and the color filters included in each transmissive liquid-crystal display device have the spectral transmittance shown in FIG. 44. Each transmissive liquid-crystal display device displays an image by using a backlight (light source is a cold cathode fluorescent tube (CCFT, CCFL)). The spectral characteristics of the light source are appropriately adjusted so that the chroma of white display is x=0.313, y=0.329, and the color temperature of white display is 6500 K. In Table 1, the brightness of yellow display has a certain range. This means that the brightness of yellow display is at a minimum (48.0) when yellow is displayed by turning on the yellow pixels without turning on the red and green pixels, and is at a maximum (92.4) when yellow is displayed by turning on the red and green pixels in addition to the yellow pixels. When yellow is displayed by turning on the red, green, and yellow pixels at an appropriate ratio, the brightness of yellow display is equal to an intermediate value.

As is clear from Tables 1 and 2, it has been found that the brightnesses of red display, green display, and blue display are all lower in the four-primary-color transmissive liquid-crystal display device according to the related art than in the three-primary-color transmissive liquid-crystal display device according to the related art. This is because since the number of primary colors used for display is increased, the number of pixels is increased and the area of each pixel is reduced accordingly. More specifically, since the number of primary colors used for display is increased from 3 to 4, the area of each pixel is reduced to ¾. The reduction in brightness of each display color has been studied. With regard to green display and blue display, the visibility is not reduced even when the brightness is reduced. However, with regard to red display, black red, that is, dark red is displayed when the brightness is reduced, and the visibility is easily reduced accordingly.

Next, the present inventors have focused attention on the spectral characteristics of the light source used for display in the four-primary-color transmissive liquid-crystal display device according to the related art. FIG. 45 shows the spectral characteristics of the light source used for display in the four-primary-color transmissive liquid-crystal display device according to the related art, and FIG. 46 shows the spectral characteristics of the light source used for display in the three-primary-color transmissive liquid-crystal display device according to the related art. In the four-primary-color transmissive liquid-crystal display device according to the related art, the pixels include the yellow pixels in addition to the red, green, and blue pixels. Therefore, if a light source having ordinary spectral characteristics as shown in FIG. 46 is used, white display will be yellowish. Accordingly, to adjust the color of white display, a light source that emits light in which the intensity of blue is relatively high and which has a high color temperature, as illustrated in FIG. 45, is used. For example, in the case where a CCFT is used, the color temperature is increased by increasing the emission of blue light and reducing the emission of green light and red light. In the case where a white light emitting diode (LED) is used, the color temperature is increased by increasing the blue component and reducing the yellow component. In the case where red, green, and blue LEDs are used, similar to the case where a CCFT is used, the color temperature is increased by reducing the green and red components and increasing the blue component. Thus, in the four-primary-color transmissive liquid-crystal display device according to the related art, the color temperature of the light source is increased to adjust the color of white display. Since it is necessary to reduce the yellow or red component of the light from the light source, the red component of the light from the light source has a low intensity.

As a result of the above, it has been found that, in the four-primary-color transmissive liquid-crystal display device according to the related art, the increase in the number of primary colors used for display causes a reduction in brightness of, in particular, red, and this leads to degradation of visibility. In addition, when a light source that emits light having a high color temperature is used to adjust the color of white display, the brightness of red display is further reduced and the visibility is further degraded accordingly.

The above discussion can be summarized as follows. That is, in a multiple-primary-color display device according to the related art which includes yellow (Ye) pixels, red is displayed as black red since the brightness of the red primary color is low. In the multiple-primary-color display device according to the related art which includes the yellow pixels, the area of the red pixels is smaller than that in a display device according to the related art which includes RGB pixels. In addition, since the yellow pixels are added, the red and green components of the backlight are reduced relative to the blue component to adjust the white balance. The red brightness is reduced owing to the pixel area and the spectral characteristics of the backlight.

The present invention has been made in light of the above-described circumstances, and an object of the present invention is to provide a display device capable of presenting a display with a large color reproduction range and displaying bright red.

### Solution to Problem

The present inventors have conducted various studies with regard to display devices that form images by using red, green, blue, and yellow pixels, and focused attention on a configuration of a light source for adjusting brightness of each color to be displayed (display color). Intensive studies have been conducted to improve the brightness of the red primary color by appropriately setting the spectral shape (peak wavelength and half-width) of the light source instead of the peak intensities of respective colors, which are the spectral characteristics of light sources that generally attract attention.

As a result of the intensive studies, the present inventors have found that bright red can be displayed by specifying the spectral shape of the light source, and the visibility can be increased accordingly. As described above, research and development of light sources for display devices, such as backlights for liquid-crystal display devices, have progressed in recent years and it has become much easier to adjust the spectral shape than before. This contributed to the concept of the present invention in which the spectral shape (peak wavelength and half-width) of the light emitted from the light source is specified.

It has also been found that, theoretically, the above-described operational effects can be achieved not only in transmissive liquid-crystal display devices that from images by using only the red, green, blue, and yellow pixels but also in transmissive liquid-crystal display devices that from images by using magenta and/or cyan pixels in addition to the red, green, blue, and yellow pixels, and can also be achieved not only in transmissive liquid-crystal display devices but also in liquid-crystal display devices of other display methods, such as reflective or reflective-transmissive liquid-crystal display devices including an auxiliary light source, such as a front light, and various other display devices such as cathode-ray tubes (CRTs), organic electro-luminescence displays (OELDs), plasma display panels (PDPs), and field emission displays (FEDs) such as surface-conduction electron-emitter displays (SEDs). The present inventors have found that the above-described problem can be solved, and arrived at the present invention.

According to the invention described in PTL 1, to solve the above-described problem, attention is focused on the brightness of each color to be displayed (display color) and the opening area of each pixel is changed. According to the present invention, in the display device described in PTL 1 in which the opening area of each pixel is changed, the spectral shape of the light emitted from the light source is adjusted so that the red brightness can be significantly increased. Alternatively, the red brightness can be sufficiently increased in a display device in which the opening area of each pixel is not changed between the colors.

A display device according to an aspect of the present invention (hereinafter referred to also as a “first display device”) forms an image by using red, green, blue, and yellow pixels. The display device includes a light source. Light emitted from the light source has a red peak wavelength of 615 nm or more and 650 nm or less, and a half-width of the red peak is 15 nm or more and 70 nm or less when the peak wavelength is 615 nm or more and 635 nm or less, 40 nm or more and 93 nm or less when the peak wavelength is more than 635 nm and 640 nm or less, and 57 nm or more and 93 nm or less when the peak wavelength is more than 640 nm and 650 nm or less.

According to the present invention, the red brightness can be increased by changing the spectral shape (peak wavelength and half-width) of the light source. For example, the effect that the red brightness can be improved can be further enhanced by adopting the pixel structure described in PTL 1, or the occurrence of image defects can be sufficiently reduced when the areas of the pixels do not largely differ from each other. Here, examples of image defects include flicker, burn-in, and crosstalk which occur when the areas of the pixels differ by large amounts and the charging rate, the amount of pixel potential pulled by a gate signal, the amount of pixel potential varied by a source signal, etc., greatly differ between the pixels.

The first to third display devices according to the present invention will now be successively described. The first to third display devices according to the present invention are in common in that they are multiple-primary-color display devices which form images by using red, green, blue, and yellow pixels, and the spectral shape (peak wavelength and/or peak half-width) of the light source is specified. Accordingly, a display with a large color reproduction range can be presented, and bright red can be displayed. Since these features are beyond the related art, they are linked as to form a single general inventive concept.

The red peak wavelength is 615 nm or more. To further improve the red brightness, the red peak wavelength is preferably 635 nm or less. In this specification, the peak wavelength is the wavelength at which the emission intensity is at a maximum. A dominant wavelength, which will be described below, is a wavelength that corresponds to a singe wavelength that is visually sensed by a human. Here, the dominant wavelength of a certain color is defined as the wavelength at a position where the spectrum locus crosses the extension of a straight line that connects a chromaticity point of that color and a white point (x=0.3333, y=0.3333 in this example) on a chromaticity diagram.

The display devices according to the present invention form images by using red, green, blue, and yellow pixels. In this specification, the “pixels” are the smallest elements that are provided on a display surface and to each of which a color or brightness is assigned in a display image. The “pixels” may be picture elements (sub-pixels) unless specified otherwise. As long as the effects of the present invention can be achieved, the combination of the pixels is not limited to the combination of all pixels. In addition, two or more types of pixels that have the same color but have different color properties may be provided. In the present invention, the pixels include not only pixels for displaying red, green, and blue (red, green, and blue pixels) but also pixels for displaying yellow (yellow pixels). In other words, in the display devices according to the present invention, the number of primary colors used for display is greater than 3. Therefore, the color reproduction range is larger than that of a display device in which the number of primary colors used for display is 3. The pixels may include, for example, pixels for displaying magenta (magenta pixels) in addition to the red, green, blue, and yellow pixels. However, preferably, only red, green, blue, and yellow pixels are provided from the viewpoint of transmittance of color filters for white display. Since magenta pixels have a low transmittance, when the magenta pixels are provided, there is a risk that light utilization efficiency of the color filters cannot be increased. Even when the magenta pixels are not provided, magenta with high color purity can be displayed by increasing the color purities of the red and blue pixels. The configuration in which only red, green, blue, and yellow pixels are provided is not limited as long as it can be said that the configuration substantially includes only red, green, blue, and yellow pixels in the technical field of the present invention.

In the display devices according to the present invention, the pixel configuration (pixel pattern) is not particularly limited, and a stripe pattern, a diagonal pattern, a matrix pattern, etc., may be used.

The above-described light source is generally used for display, and is preferably, for example, a backlight and/or a front light. Each of the display devices according to the present invention is preferably a liquid-crystal display device such as, for example, a transmissive liquid-crystal display device that displays an image by using a backlight, a reflective liquid-crystal display device that displays an image by using a front light, or a reflective-transmissive liquid-crystal display device that performs a transmissive display operation by using a backlight and a reflective display operation by using external light and/or a front light. More preferably, the above-described light source is a backlight. For example, each of the display devices is preferably a transmissive liquid-crystal display device that displays an image by using a backlight or a reflective-transmissive liquid-crystal display device that performs a transmissive display operation by using a backlight and a reflective display operation by using external light and/or a front light. The above-described backlight may be a direct backlight or an edge lighting backlight. In addition, the above-described light source is preferably a light source including, for example, a nano fluorescent material so that the spectral shape can be appropriately adjusted. As long as the effects of the present invention can be achieved, the light source according to the present invention may instead be a white light emitting diode (LED), an RGB-LED, a cold cathode fluorescent tube (CCFT), a hot cathode fluorescent tube (HCFT), an organic EL, etc., as appropriate.

In this specification, the spectrum of the backlight does not mean the spectrum of the light source itself but means the spectrum of a backlight unit in which the light source is installed. In the case where the backlight is controlled, the spectrum of the backlight is the spectrum of the backlight unit at the time when an input signal is a full-while signal. In this specification, light emitted from the light source means light emitted from a light source device in which the light source is installed.

In addition, in this specification, each pixel preferably includes a filter that selectively transmits light with a specific wavelength range (hereinafter referred to also as a “color filter”). For example, each of the above-described display devices preferably includes a color filter substrate in which at least red, green, blue, and yellow color filters are arranged so as to correspond to the respective pixels. In this case, the color of each pixel is determined by the spectral characteristics of the corresponding color filter. The material of each color filter is not particularly limited, and may be, for example, a resin that is dyed with a colorant, a resin in which a pigment is dispersed, or a material obtained by solidifying a flowable material (ink) in which a pigment is dispersed. A method for forming each color filter may be, for example, a dyeing method, a pigment dispersion method, an electrodeposition method, a printing method, an inkjet method, a color resist method (also referred to as a “transferring method”, a “dry film laminate (DFL) method”, or a “dry film resist method”).

In addition, in this specification, the color of each pixel is defined as follows. That is, “red” is a color having a dominant wavelength of 595 nm or more and 650 nm or less, more preferably, 600 nm or more and 640 nm or less, when the white point is at x=0.3333, y=0.3333 in the xy chromaticity diagram of the XYZ color system (CIE 1931 standard color system). Similarly, “green” is a color having a dominant wavelength of 490 nm or more and 555 nm or less, more preferably, 510 nm or more and 550 nm or less. Similarly, “blue” is a color having a dominant wavelength of 450 nm or more and 490 nm or less, more preferably, 450 nm or more and 475 nm or less. Similarly, “yellow” is a color having a dominant wavelength of 565 nm or more and 580 nm or less, more preferably, 570 nm or more and 580 nm or less. The dominant wavelength and complementary wavelength generally show a color phase.

Preferred embodiments of the first display device according to the present invention will now be described in detail.

Among the pixels, the red pixels preferably have the largest area. In the display device according to the present invention, the red brightness can be significantly improved when the red pixels have the largest area. For example, among the pixels, the red pixels preferably have the largest area and the green, blue, and yellow pixels preferably have the smallest area. In other words, preferably, the green, blue, and yellow pixels have the same area, and the area of the green, blue, and yellow pixels is the smallest. In addition, it is also preferable that the red and blue pixels have the largest area. Also in this case, the red brightness can be significantly improved. The configuration in which the red and blue pixels have the largest area may be a configuration in which the numbers of red and blue pixels are the largest among the pixels, a configuration in which the area of each of the red and blue pixels is the largest among the pixels, or a combination of these configurations.

In the configuration in which the numbers of red and blue pixels are the largest among the pixels, it is not necessary to change the area of each pixel. Therefore, this configuration is preferable in that the pixel design and circuit design according to the related art can be used. In this specification, the configuration in which “the numbers of red and blue pixels are the largest among the pixels” means that the numbers of red and blue pixels included in the pixels are equal to each other and are the largest, and the numbers of pixels other than red and blue pixels are smaller than the number of red pixels (in other words, the number of blue pixels). In addition, in this specification, a configuration in which pixels have “different color properties” means that at least one of the three attributes of color, which are hue, brightness, and saturation, differs between the pixels. Preferably, the pixels have different hues from the viewpoint of efficiently increasing the color reproduction range.

In the case where the red and blue pixels have the largest area and the green and yellow pixels have the smallest area, the transmittance of the color filters for white display decreases. However, the transmittance of blue components of the color filters relatively increases. Therefore, the blue component of the light emitted from the light source having a low luminous efficiency can be reduced to optimize the chroma of white display, so that the luminous efficiency of the light source can be increased. Thus, owing also to the luminous efficiency of the light source, the brightness of white display of the display device can be effectively increased. The red and blue pixels may have the largest area while the green pixels have the smallest area. Alternatively, the red and blue pixels may have the largest area while the yellow pixels have the smallest area.

It is also preferable that the red, green, blue, and yellow pixels have the same area. In this case, the occurrence of defects such as flicker, burn-in, and crosstalk can be sufficiently reduced. To sufficiently reduce the occurrence of defects and improve the red brightness, the ratio of the area of the red pixels to the area of the pixels of another color that have the smallest area is, for example, preferably 1 or more and 2 or less. More preferably, the ratio is 1.6 or less. In other words, the ratio between the areas of the pixels of the respective colors is preferably 1 or more and 1.6 or less in the above-described display device.

In this specification, the pixel area means the area of regions used for display (active regions or effective regions), and may be referred to as an “opening area” in a display device including color filters. In this specification, the opening area means the area of regions that are actually used for display, and do not include the area of light blocking regions in which thin-film transistors (TFT), scanning lines, signal lines, auxiliary capacitors, a black matrix, etc., are arranged. A method for relatively increasing the opening area of the pixels include (1) a method of increasing the opening area of each pixel, (2) a method of increasing the number of pixels, (3) a combination of methods (1) and (2). To prevent the structure from becoming complex, method (1) is preferably used. This is because the number of switching elements, such as thin-film transistors (TFTs), for driving the pixels is not increased when this method is used.

In the above-described display device, the color temperature of white light emitted from a display surface is preferably less than 12000 K. The color temperature is more preferably 10000 K or less, and still more preferably, 9000 K or less.

Another display device according to the present invention (hereinafter referred to also as a “second display device”) forms an image by using red, green, blue, and yellow pixels. The display device includes a light source. Light emitted from the light source has a green peak wavelength of 510 nm or more and 538 nm or less. The green peak wavelength is preferably 535 nm or less. Also in this case, the red brightness can be increased and the visibility of the display device can be increased as a result.

The green peak wavelength is preferably 520 nm or more. In this case, reductions in blue saturation and yellow saturation can be reliably prevented. The above-described embodiments of the first display device of the present invention (for example, the preferred ranges of the red peak wavelength and half-width) are preferably applied to the second display device of the present invention. Accordingly, the effect of the present invention that the red brightness can be increased can be enhanced.

Another display device according to the present invention (hereinafter referred to also as a “third display device”) forms an image by using red, green, blue, and yellow pixels. The display device includes a light source. Light emitted from the light source has a green peak wavelength of 510 nm or more and 540 nm or less, and a half-width of the green peak is 57 nm or less. Also in this case, the red brightness can be increased and the visibility of the display device can be increased as a result.

The half-width of the green peak is, for example, preferably 48 nm or less. In addition, the half-width of the green peak is, for example, preferably 30 nm or more.

The above-described embodiments of the first and second display devices according to the present invention may be applied as appropriate to the third display device according to the present invention as long as the effects of the present invention can be achieved.

The pixels of each color may include two or more types of pixels having different color properties.

The above-described embodiments may be combined as appropriate without departing from the scope of the present invention.

### Advantageous Effects of Invention

With the display devices according to the present invention, since an image is formed by using red, green, blue, and yellow pixels, a display with a large color reproduction range can be presented. In addition, since the spectral shape of the light emitted from the light source is specified, the brightness of red display can be increased.

### BRIEF DESCRIPTION OF DRAWINGS

FIG. 1 is a schematic plan view of a TFT substrate included in a liquid-crystal display device according to a first embodiment.

FIG. 2 is a schematic plan view of a counter substrate included in the liquid-crystal display device according to the first embodiment.

FIG. 3 is a schematic sectional view of the liquid-crystal display device according to the first embodiment.

FIG. 4 is a graph showing the relationship between the green half-width (nm) and the red brightness (%) according to the first embodiment.

FIG. 5 is a graph showing the relationship between the green half-width (nm) and the blue saturation according to the first embodiment.

FIG. 6 is a graph showing the relationship between the green half-width (nm) and the yellow saturation according to the first embodiment.

FIG. 7 is a graph showing the relationship between the green half-width (nm) and the red brightness (%) according to a second embodiment.

FIG. 8 is a graph showing the relationship between the green half-width (nm) and the blue saturation according to the second embodiment.

FIG. 9 is a graph showing the relationship between the green half-width (nm) and the yellow saturation according to the second embodiment.

FIG. 10 is a graph showing the relationship between the green half-width (nm) and the red brightness (%) according to a third embodiment.

FIG. 11 is a graph showing the relationship between the green half-width (nm) and the blue saturation according to the third embodiment.

FIG. 12 is a graph showing the relationship between the green half-width (nm) and the yellow saturation according to the third embodiment.

FIG. 13 is a graph showing the relationship between the red half-width (nm) and the red brightness (%) according to a fourth embodiment.

FIG. 14 is a distribution chart of the red brightness (%) in which the vertical axis represents the red half-width (nm) and the horizontal axis represents the red peak wavelength (nm) according to the fourth embodiment.

FIG. 15 is a graph showing the relationship between the red half-width (nm) and the blue saturation according to the fourth embodiment.

FIG. 16 is a graph showing the relationship between the red half-width (nm) and the yellow saturation according to the fourth embodiment.

FIG. 17 is a graph showing the relationship between the red half-width (nm) and the red brightness (%) according to a fifth embodiment.

FIG. 18 is a distribution chart of the red brightness (%) in which the vertical axis represents the red half-width (nm) and the horizontal axis represents the red peak wavelength (nm) according to the fifth embodiment.

FIG. 19 is a graph showing the relationship between the red half-width (nm) and the red brightness (%) according to a sixth embodiment.

FIG. 20 is a distribution chart of the red brightness (%) in which the vertical axis represents the red half-width (nm) and the horizontal axis represents the red peak wavelength (nm) according to the sixth embodiment.

FIG. 21 is a graph showing the relationship between the red half-width (nm) and the red brightness (%) according to a seventh embodiment.

FIG. 22 is a distribution chart of the red brightness (%) in which the vertical axis represents the red half-width (nm) and the horizontal axis represents the red peak wavelength (nm) according to the seventh embodiment.

FIG. 23 is a graph showing the relationship between the red half-width (nm) and the red brightness (%) according to an eighth embodiment.

FIG. 24 is a distribution chart of the red brightness (%) in which the vertical axis represents the red half-width (nm) and the horizontal axis represents the red peak wavelength (nm) according to the eighth embodiment.

FIG. 25 is a graph showing the relationship between the red half-width (nm) and the red brightness (%) according to a ninth embodiment.

FIG. 26 is a distribution chart of the red brightness (%) in which the vertical axis represents the red half-width (nm) and the horizontal axis represents the red peak wavelength (nm) according to the ninth embodiment.

FIG. 27 is a graph showing the relationship between the red half-width (nm) and the red brightness (%) according to a tenth embodiment.

FIG. 28 is a distribution chart of the red brightness (%) in which the vertical axis represents the red half-width (nm) and the horizontal axis represents the red peak wavelength (nm) according to the tenth embodiment.

FIG. 29 is a graph showing the relationship between the red half-width (nm) and the red brightness (%) according to an eleventh embodiment.

FIG. 30 is a distribution chart of the red brightness (%) in which the vertical axis represents the red half-width (nm) and the horizontal axis represents the red peak wavelength (nm) according to the eleventh embodiment.

FIG. 31 is a graph showing the relationship between the red half-width (nm) and the red brightness (%) according to a twelfth embodiment.

FIG. 32 is a distribution chart of the red brightness (%) in which the vertical axis represents the red half-width (nm) and the horizontal axis represents the red peak wavelength (nm) according to the twelfth embodiment.

FIG. 33 is a schematic plan view of a counter substrate included in a liquid-crystal display device according to a thirteenth embodiment.

FIG. 34 is a schematic sectional view of the liquid-crystal display device according to the thirteenth embodiment.

FIG. 35 is a graph showing the relationship between the red half-width (nm) and the red brightness (%) according to the thirteenth embodiment.

FIG. 36 is a distribution chart of the red brightness (%) in which the vertical axis represents the red half-width (nm) and the horizontal axis represents the red peak wavelength (nm) according to the thirteenth embodiment.

FIG. 37 is a schematic plan view of a counter substrate included in a liquid-crystal display device according to a fourteenth embodiment.

FIG. 38 is a schematic sectional view of the liquid-crystal display device according to the fourteenth embodiment.

FIG. 39 is a graph showing the relationship between the red half-width (nm) and the red brightness (%) according to the fourteenth embodiment.

FIG. 40 is a distribution chart of the red brightness (%) in which the vertical axis represents the red half-width (nm) and the horizontal axis represents the red peak wavelength (nm) according to the fourteenth embodiment.

FIG. 41 is a graph showing the relationship between the wavelength (nm) and the intensity which shows the spectrum of a backlight used in Example 1-3.

FIG. 42 is a graph showing the relationship between the wavelength (nm) and the intensity which shows the spectrum of a backlight used in Example 5-4.

FIG. 43 is a graph showing the relationship between the wavelength (nm) and the intensity which shows the spectrum of a backlight used in Reference 1-1.

FIG. 44 is a graph showing the spectral transmittance characteristics of a color filter.

FIG. 45 is a graph showing the spectral characteristics of a light source of a backlight included in a four-primary-color liquid-crystal display device according to the related art.

FIG. 46 is a graph showing the spectral characteristics of a light source of a backlight included in a three-primary-color liquid-crystal display device according to the related art.

### DESCRIPTION OF EMBODIMENTS

The present invention will be described in more detail by way of embodiments. However, the present invention is not limited to the embodiments. Configurations, measurement values, etc., in the following embodiments are all based on simulations performed by using a computer program. In the following embodiments, the present invention is described by using transmissive liquid-crystal display devices as examples.

In this specification, “half-width” means a width between wavelengths that are on both sides of a peak wavelength and at which the intensity is half the intensity at the peak wavelength. In the case where the intensity is reduced to half only on one side of the peak wavelength, the half-width is determined as twice the difference between the wavelength at which the intensity is half and the peak wavelength. In addition, in this specification, “combination of pixels” is the base unit for display in which pixels of a plurality of colors are combined. This unit may simply be referred to as a “pixel” in the technical field of the present invention. In addition, in the following embodiments, the red brightness (%) is a value determined by assuming that the red brightness according to a comparative example of Reference 2-1 described below, which is an example of the related art (in which, in the spectrum of a backlight light source, green peak wavelength and half-width are 540 nm and 58 nm, respectively, and red peak wavelength and half-width are 640 nm and 97 nm, respectively) is 100%.

### First Embodiment

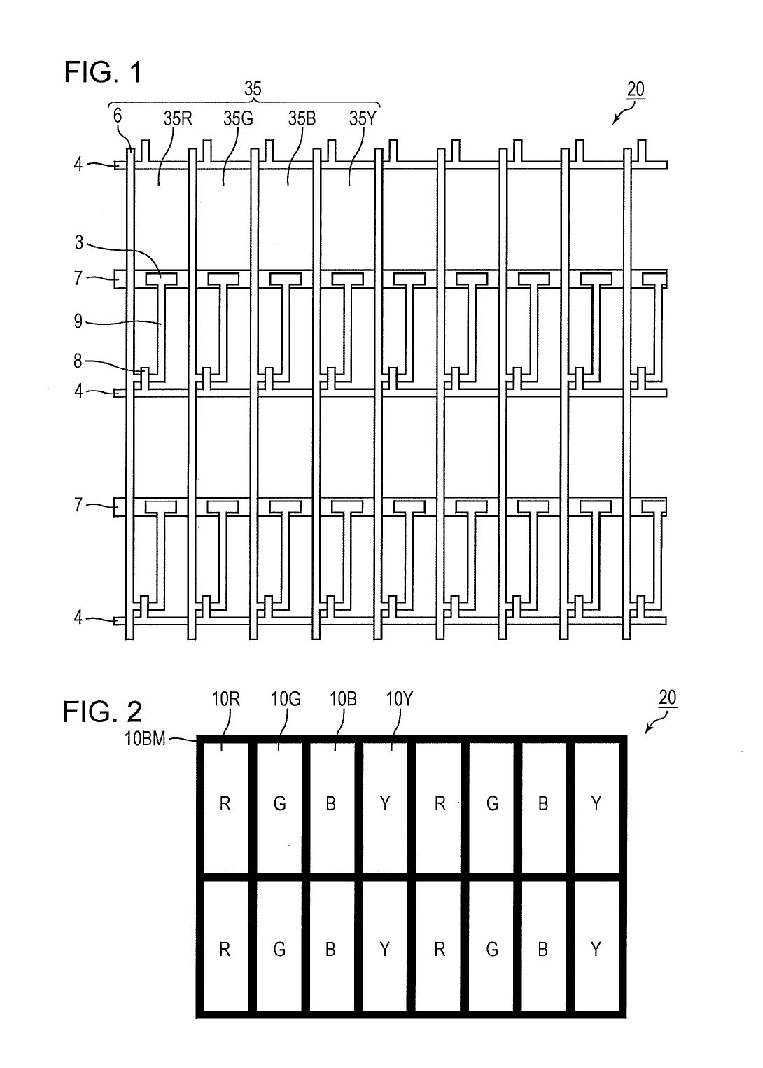

The structure of a liquid-crystal display device according to a first embodiment of the present invention will now be described. FIG. 1 is a schematic plan view of a TFT substrate included in the liquid-crystal display device according to the first embodiment. Referring to FIG. 1, the TFT substrate 30 includes matrix wiring arranged on a glass substrate, the matrix wiring including scanning lines 4 and signal lines 6. Thin-film transistors (TFTs) 8 are provided at intersections of the matrix wiring. Transparent electrodes 35 (35R, 35G, 35B, and 35Y) made of a transparent conductive material, such as indium tin oxide (ITO), are arranged in regions surrounded by the lines of the matrix wiring. The TFTs 8 include gate electrodes connected to the scanning lines 4, source electrodes connected to the signal lines 6, and drain electrodes connected to the transparent electrodes 35 by drain lead wires 9. The transparent electrodes 35R, 35G, 35B, and 35Y are arranged so as to respectively oppose red, green, blue, and yellow color filters 10R, 10G, 10B, and 10Y provided on a counter substrate 20, which will be described below, in the liquid-crystal display device. In the present embodiment, as illustrated in FIG. 1, the scanning lines 4 and the signal lines 6 are arranged so that the transparent electrodes 35R, 35G, 35B, and 35Y have the same size. Auxiliary capacitor lines 7, which hold voltages applied to the transparent electrodes 35, are arranged parallel to the scanning lines 4. The auxiliary capacitor lines 7 oppose end portions of the drain lead wires 9 with an insulating film interposed therebetween, thereby constituting auxiliary capacitors 3.

FIG. 2 is a schematic plan view of a color filter substrate (counter substrate) included in the liquid-crystal display device according to the first embodiment. As illustrated in FIG. 2, the counter substrate 20 includes the red, green, blue, and yellow color filters 10R, 10G, 10B, and 10Y arranged in that order in a stripe pattern, and a black matrix 10BM is arranged so as to extend along regions between the filters. Each of the color filters 10R, 10G, 10B, and 10Y selects the color of light allowed to pass therethrough. The red, green, and blue color filters 10R, 10G, and 10B mainly transmit a red component, a green component, and a blue component, respectively, of light incident thereon. The yellow color filter 10Y mainly transmits both a red component and a green component of light incident thereon. The color filters 10R, 10G, 10B, and 10Y are arranged so as to respectively oppose the transparent electrodes 35R, 35G, 35B, and 35Y provided on the above-described TFT substrate 30 in the liquid-crystal display device. The black matrix 10BM is arranged so as to oppose the scanning lines 4 and the signal lines 6 in the liquid-crystal display device. In the first embodiment, as illustrated in FIG. 2, the color filters 10R, 10G, 10B, and 10Y have the same area. In other words, in the liquid-crystal display device according to the first embodiment, the opening areas of red, green, blue, and yellow are equal to each other (the opening ratio is R:G:B:Y=1:1:1:1).

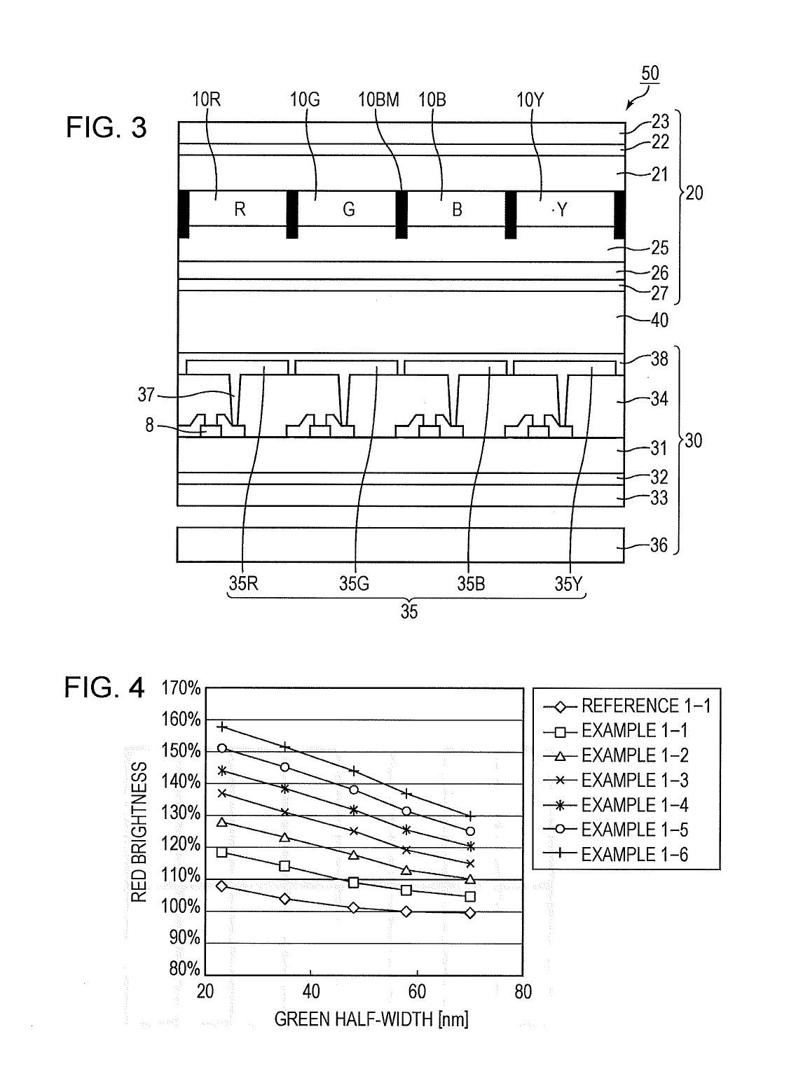

FIG. 3 is a schematic sectional view of the liquid-crystal display device according to the first embodiment. As illustrated in FIG. 3, the liquid-crystal display device 50 according to the first embodiment of the present invention includes a liquid crystal layer 40 interposed between the above-described counter substrate 20 and the above-described TFT substrate 30. The counter substrate 20 includes a retardation plate 22 and a polarizing plate 23 on an outer side (viewing side) of a glass substrate 21, and the red, green, blue, and yellow color filters 10R, 10G, 10B, 10Y, the black matrix 10BM, an overcoat layer 25, a counter electrode 26, and an alignment film 27 on an inner side (back side) of the glass substrate 21.

The retardation plate 22 adjusts the polarization of light that passes therethrough. The polarizing plate 23 transmits only a component of light that has a specified polarization. In the present embodiment, a viewing angle compensation function is provided by adjusting the arrangement and structure of the retardation plate 22 and the polarizing plate 23.

The overcoat layer 25 prevents contaminant from leaking into the liquid crystal layer 40 from the red, green, blue, and yellow color filters 10R, 10G, 10B, and 10Y, and flattens the surface of the counter substrate 100. The counter electrode 26 opposes the transparent electrodes 35R, 35G, 35B, and 35Y included in the TFT substrate 30 with the liquid crystal layer 40 interposed therebetween, and is used to apply a voltage to the liquid crystal layer 40 to drive liquid crystal molecules. The counter electrode 26 is made of a transparent conductive material, such as indium tin oxide (ITO). The alignment film 27 controls the alignment of the liquid crystal molecules in the liquid crystal layer 40.

The TFT substrate 30 includes a retardation plate 32 and a polarizing plate 33 on an outer side (back side) of a glass substrate 31, and the thin-film transistors (TFTs) 8, an interlayer insulation film 34, the transparent electrodes 35 (35R, 35G, 35B, and 35Y), and an alignment film 38 on an inner side (viewing side) of the glass substrate 31.

Similar to the retardation plate 22, the retardation plate 32 adjusts the polarization of light that passes therethrough. Similar to the polarizing plate 23, the polarizing plate 33 transmits only a component of light that has a specified polarization. In the present embodiment, the polarizing plate 33 is arranged so as to be optically orthogonal to the polarizing plate included in the counter substrate 20.

The transparent electrodes 35 (35R, 35G, 35B, and 35Y) are arranged so as to correspond to the respective color filters included in the counter substrate 20, and apply a voltage to the liquid crystal layer 40 so as to drive the liquid crystal molecules in the region of each color filter individually. Similar to the alignment film 27, the alignment film 38 controls the alignment of the liquid crystal molecules in the liquid crystal layer 40. The TFT substrate 30 includes a backlight 36 used for display at a rear side (back side) thereof.

The TFT substrate 30 includes a backlight 36 used for display at a rear side (back side) thereof. The spectral characteristics and the like of the light source included in the backlight 36 will be described in detail below. In the present embodiment, nematic liquid crystal is used as the material of the liquid crystal layer 40.

Table 3 below shows the green peak wavelength (nm), the green half-width (23 nm, 35 nm, 48 nm, 58 nm, and 70 nm), the red peak wavelength (nm), and the red half-width (nm) in the first embodiment (Examples 1-1 to 1-6 and Reference 1-1). With regard to Reference 1-1, cases in which the green half-width is 58 nm and 70 nm are comparative examples.

TABLE 3

| | Green | | Red | |
|---|---|---|---|---|
| | Peak | | Peak | |
| | wavelength | Half-width | wavelength | Half-width |
| | (nm) | (nm) | (nm) | (nm) |
| Reference 1-1 | 540 | 23-70 | 645 | 97 |
| Example 1-1 | 535 | | | |
| Example 1-2 | 530 | | | |
| Example 1-3 | 525 | | | |
| Example 1-4 | 520 | | | |
| Example 1-5 | 515 | | | |
| Example 1-6 | 510 | | | |

FIG. 4 is a graph showing the relationship between the green half-width (nm) and the red brightness (%) according to the first embodiment.

In the first embodiment, as described above, the opening ratio is R:G:B:Y=1:1:1:1. In addition, the color temperature of white light emitted from the display surface is 10000 K (x=0.278, y=0.291), and the red peak wavelength λp and the red half-width in the spectrum of the backlight light source are 645 nm and 97 nm, respectively. According to the first embodiment, in the case where the red peak wavelength λp is 645 nm, the red brightness can be increased by reducing the green (G) peak wavelength to, for example, 538 nm or less. The green peak wavelength is preferably 535 nm or less, and more preferably, 525 nm or less. When the green peak wavelength is constant, as is clear from FIG. 4, the effect of increasing the red brightness can be increased as the green half-width is reduced. In green light emitted from a backlight used in four-primary-color display according to the related art, the peak wavelength is 540 nm and the half-width is substantially 60 nm (58 nm or more).

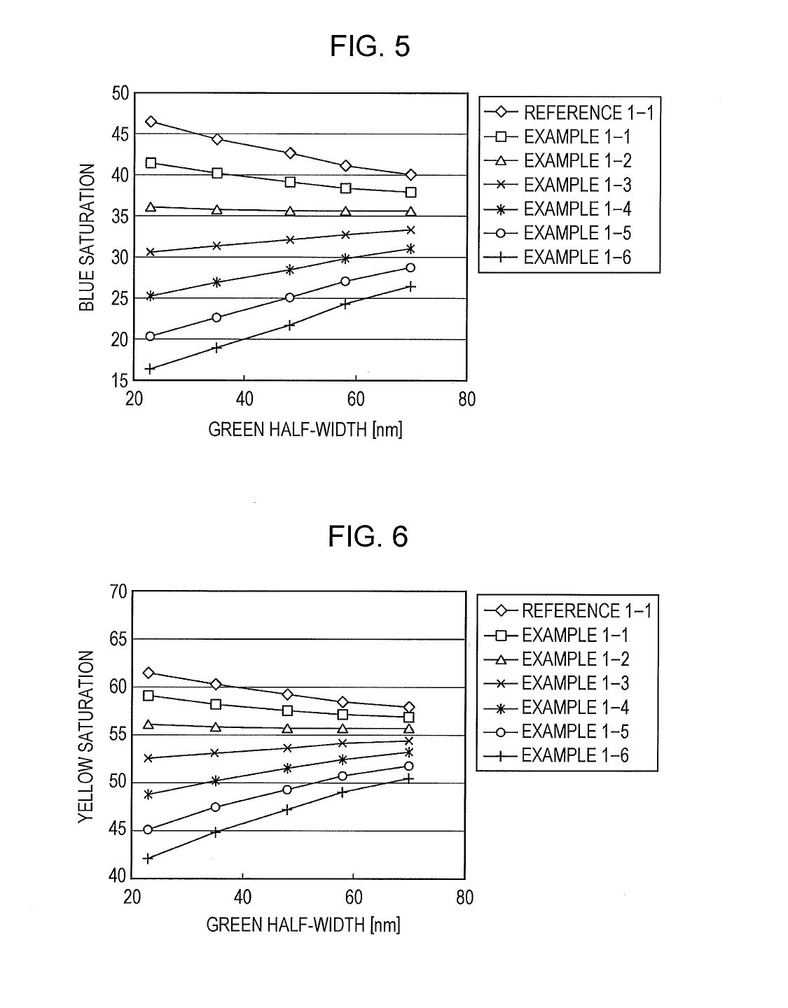

FIG. 5 is a graph showing the relationship between the green half-width (nm) and the blue saturation according to the first embodiment. FIG. 6 is a graph showing the relationship between the green half-width (nm) and the yellow saturation according to the first embodiment. As the green peak wavelength λp is reduced, for example, when λp<515 nm, the red brightness is further increased. However, in this case, the saturation of blue display decreases as illustrated in FIG. 5, and the saturation of yellow display decreases as illustrated in FIG. 6. Therefore, λp≧520 nm is preferably satisfied. More preferably, λp≧525 nm is satisfied.

### Second Embodiment

Table 4 below shows the green peak wavelength (nm), the green half-width (23 nm, 35 nm, 48 nm, 58 nm, and 70 nm), the red peak wavelength (nm), and the red half-width (nm) in the second embodiment (Examples 2-1 to 2-6 and Reference 2-1). With regard to Reference 2-1, cases in which the green half-width is 58 nm and 70 nm are comparative examples.

TABLE 4

| | Green | | Red | |
|---|---|---|---|---|
| | Peak | | Peak | |
| | wavelength | Half-width | wavelength | Half-width |
| | (nm) | (nm) | (nm) | (nm) |
| Reference 2-1 | 540 | 23-70 | 640 | 97 |
| Example 2-1 | 535 | | | |
| Example 2-2 | 530 | | | |
| Example 2-3 | 525 | | | |
| Example 2-4 | 520 | | | |
| Example 2-5 | 515 | | | |
| Example 2-6 | 510 | | | |

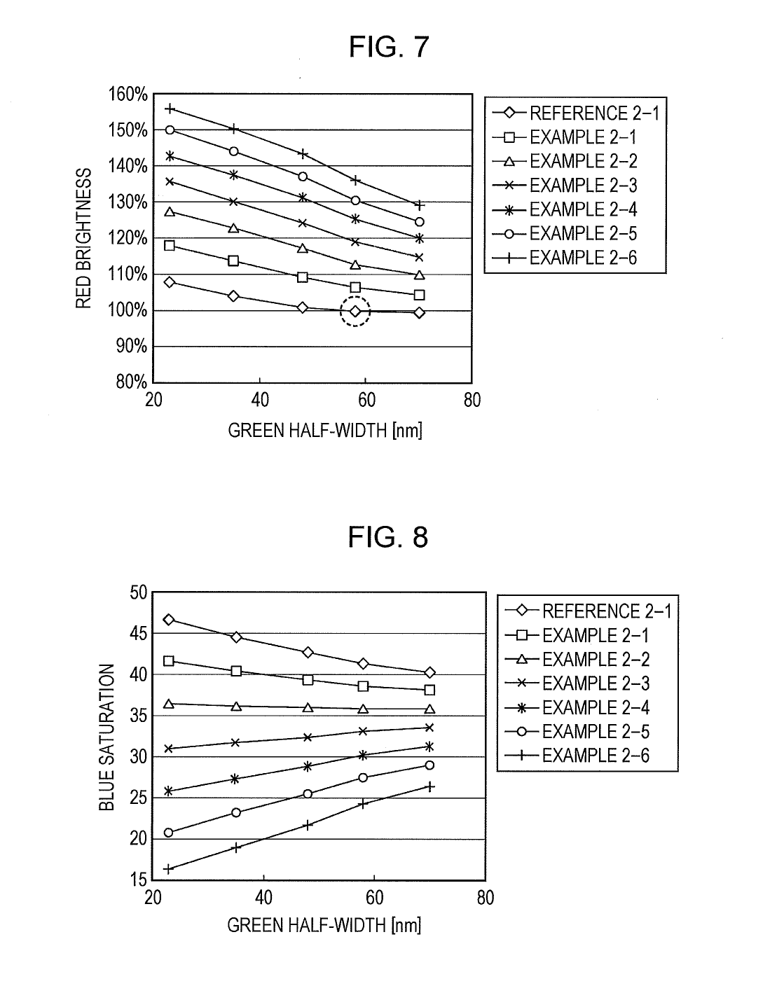

FIG. 7 is a graph showing the relationship between the green half-width (nm) and the red brightness (%) according to the second embodiment.

The structure of the second embodiment is similar to that of the first embodiment except that the red peak wavelength λp in the spectrum of the backlight light source is 640 nm instead of 645 nm. According to the second embodiment, in the case where the red (R) peak wavelength λp is 640 nm, the red brightness can be increased by reducing the green (G) peak wavelength to, for example, 538 nm or less. The green (G) peak wavelength is preferably 535 nm or less. When the green peak wavelength is constant, as is clear from FIG. 7, the effect of increasing the red brightness can be increased as the green half-width is reduced. In FIG. 7, the data of Reference 2-1 circled by the dotted line corresponds to the case in which the half-width is 58 nm. The red brightness in this case is defined as 100%, and this is an example of a case in which a general backlight according to the related art is used. According to the present embodiment, the red brightness can be made higher than that according to the related art.

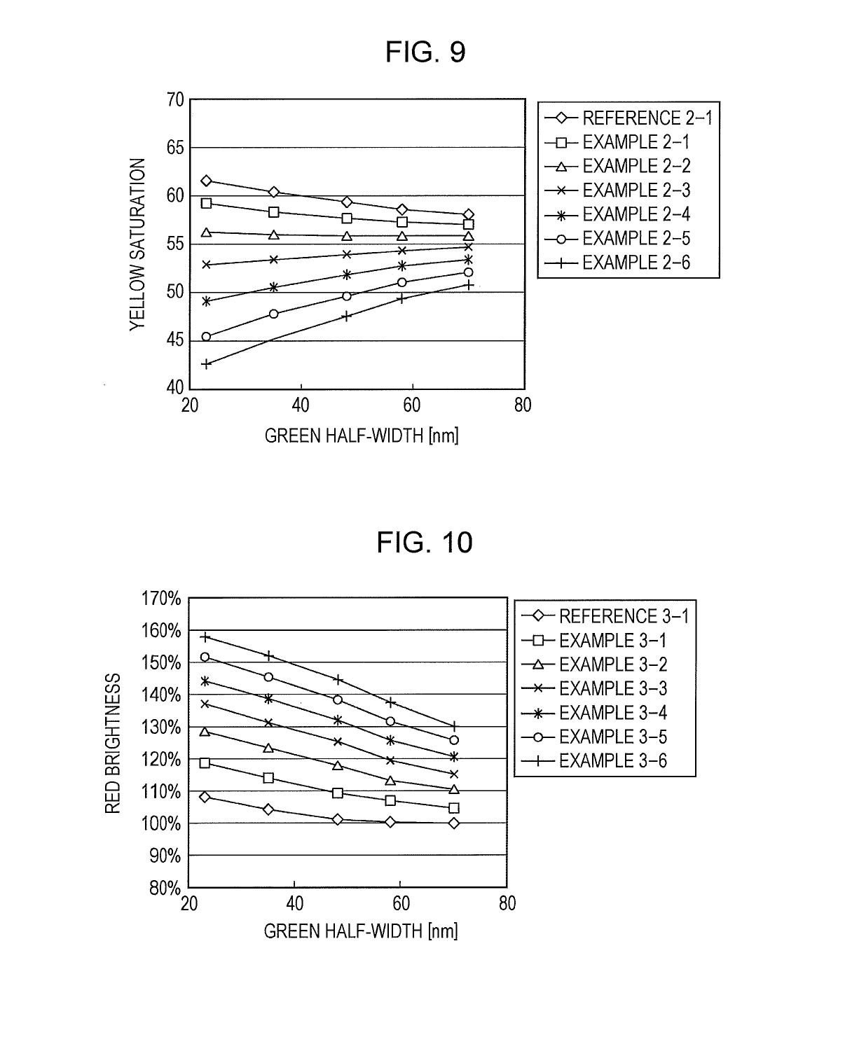

FIG. 8 is a graph showing the relationship between the green half-width (nm) and the blue saturation according to the second embodiment. FIG. 9 is a graph showing the relationship between the green half-width (nm) and the yellow saturation according to the second embodiment.

As the green (G) peak wavelength λp is reduced, for example, when λp<515 nm, the red brightness is further increased. However, in this case, the saturation of blue display decreases as illustrated in FIG. 8, and the saturation of yellow display decreases as illustrated in FIG. 9. Therefore, λp≧520 nm is preferably satisfied. More preferably, λp≧525 nm is satisfied.

### Third Embodiment

Table 5 below shows the green peak wavelength (nm), the green half-width (23 nm, 35 nm, 48 nm, 58 nm, and 70 nm), the red peak wavelength (nm), and the red half-width (nm) in the third embodiment (Examples 3-1 to 3-6 and Reference 3-1). With regard to Reference 3-1, cases in which the green half-width is 58 nm and 70 nm are comparative examples.

TABLE 5

| | Green | | Red | |
|---|---|---|---|---|
| | Peak | | Peak | |
| | wavelength | Half-width | wavelength | Half-width |
| | (nm) | (nm) | (nm) | (nm) |
| Reference 3-1 | 540 | 23-70 | 635 | 97 |
| Example 3-1 | 535 | | | |
| Example 3-2 | 530 | | | |
| Example 3-3 | 525 | | | |
| Example 3-4 | 520 | | | |
| Example 3-5 | 515 | | | |
| Example 3-6 | 510 | | | |

FIG. 10 is a graph showing the relationship between the green half-width (nm) and the red brightness (%) according to the third embodiment.

The structure of the third embodiment is similar to that of the first embodiment except that the red peak wavelength λp in the spectrum of the backlight light source is 635 nm instead of 645 nm. According to the third embodiment, in the case where the red (R) peak wavelength λp is 635 nm, the red brightness can be increased by reducing the green (G) peak wavelength is reduced to, for example, 538 nm or less. The green (G) peak wavelength is preferably 535 nm or less. When the green peak wavelength is constant, as is clear from FIG. 10, the effect of increasing the red brightness can be increased as the green half-width is reduced.

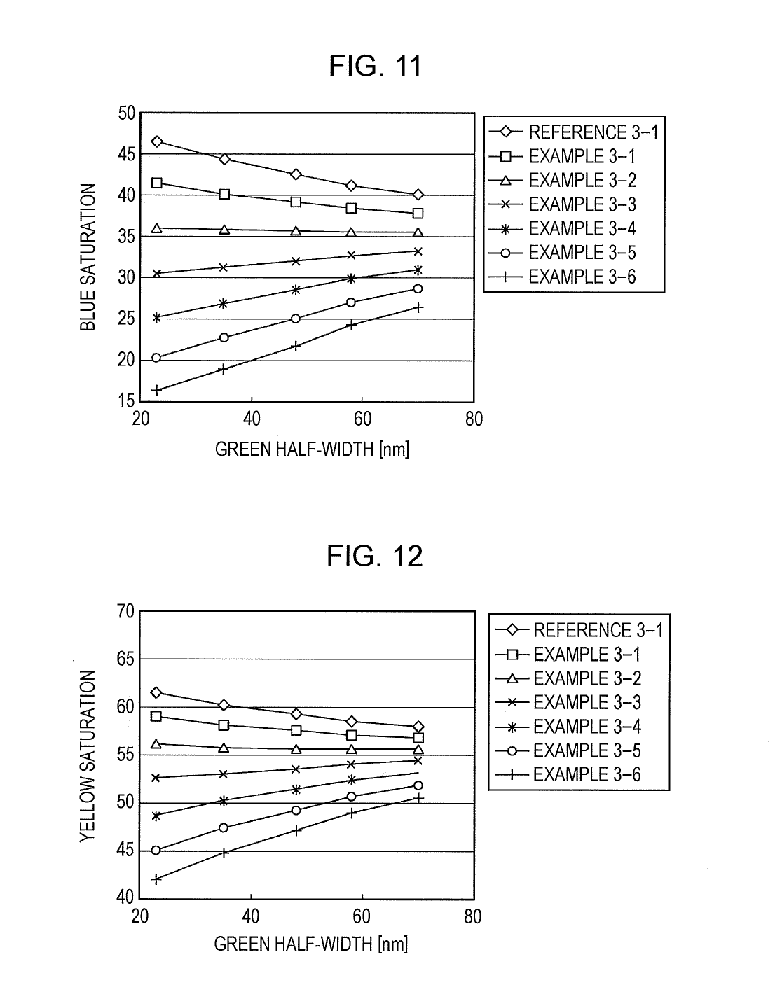

FIG. 11 is a graph showing the relationship between the green half-width (nm) and the blue saturation according to the third embodiment. FIG. 12 is a graph showing the relationship between the green half-width (nm) and the yellow saturation according to the third embodiment.

As the green (G) peak wavelength λp is reduced, for example, when λp<515 nm, the red brightness is further increased. However, in this case, the saturation of blue display decreases as illustrated in FIG. 11, and the saturation of yellow display decreases as illustrated in FIG. 12. Therefore, λp≧520 nm is preferably satisfied. More preferably, λp≧525 nm is satisfied.

According to the first to third embodiments, the red brightness can be increased irrespective of the red peak wavelength by reducing the green (G) peak wavelength. When the green peak wavelength is constant, the effect of increasing the red brightness can be increased as the green half-width is reduced (see FIGS. 4, 7, and 10).

### Fourth Embodiment

Table 6 below shows the green peak wavelength (nm), the green half-width (nm), the red peak wavelength (nm), and the red half-width (10 nm, 15 nm, 20 nm, 40 nm, 60 nm, 80 nm, and 100 nm) in the fourth embodiment (Examples 4-1 to 4-8).

TABLE 6

| | Green | | Red | |
|---|---|---|---|---|
| | Peak | | Peak | |
| | wavelength | Half-width | wavelength | Half-width |
| | (nm) | (nm) | (nm) | (nm) |
| Example 4-1 | 535 | 58 | 615 | 10-100 |
| Example 4-2 | | | 620 | |
| Example 4-3 | | | 625 | |
| Example 4-4 | | | 630 | |
| Example 4-5 | | | 635 | |
| Example 4-6 | | | 640 | |
| Example 4-7 | | | 645 | |
| Example 4-8 | | | 650 | |

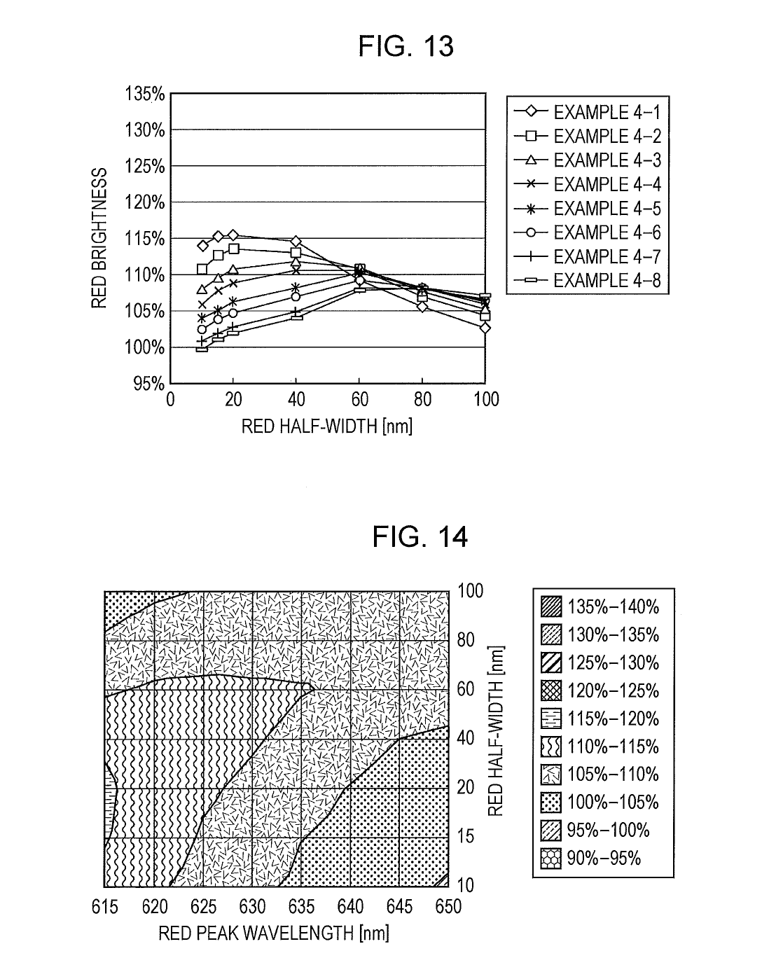

FIG. 13 is a graph showing the relationship between the red half-width (nm) and the red brightness (%) according to a fourth embodiment. In the fourth embodiment, the opening ratio is R:G:B:Y=1:1:1:1, and the color temperature of white light emitted from the display surface is 10000 K (x=0.278, y=0.291). In the case where the green (G) peak wavelength and half-width are 535 nm and 58 nm, respectively, at which the display qualities of yellow (Y) and blue (B) are not degraded, the red (R) peak wavelength and half-width for increasing the red brightness are examined. Each red peak wavelength has a half-width at which the red brightness can be maximized.

FIG. 14 is a distribution chart of the red brightness (%) in which the vertical axis represents the red half-width (nm) and the horizontal axis represents the red peak wavelength (nm) according to the fourth embodiment.

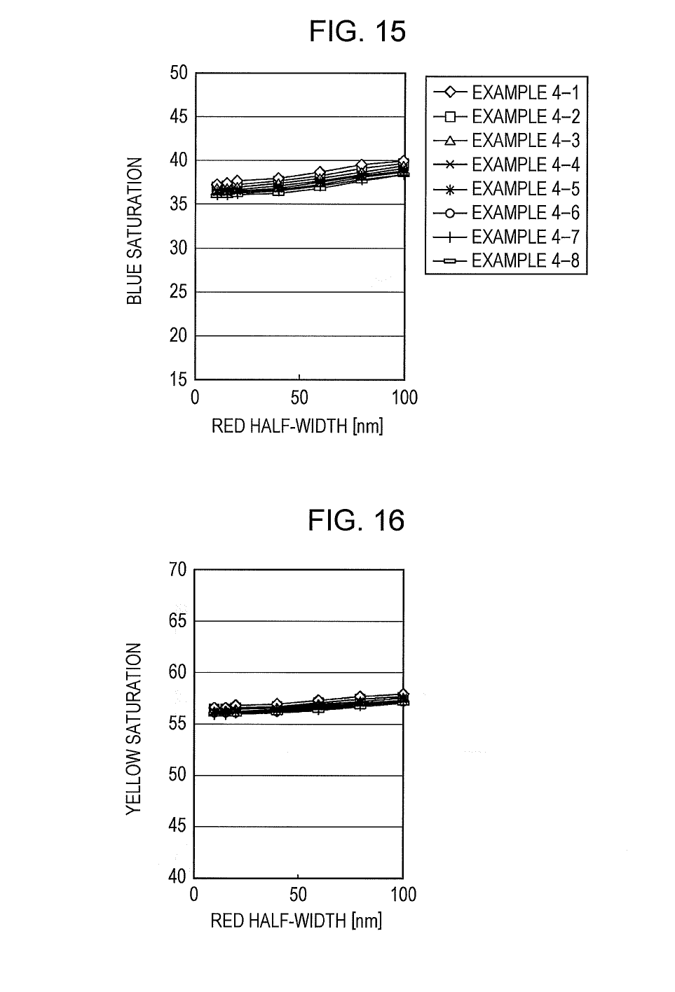

FIG. 15 is a graph showing the relationship between the red half-width (nm) and the blue saturation according to the fourth embodiment. FIG. 16 is a graph showing the relationship between the red half-width (nm) and the yellow saturation according to the fourth embodiment. In the fourth embodiment, the influence of the red peak wavelength and half-width on the blue saturation and the yellow saturation is small. Although no graph showing the relationship between the red half-width (nm) and the blue saturation or graph showing the relationship between the red half-width (nm) and the blue saturation is shown in the fifth to ninth embodiments described below, the influence on the blue saturation and the yellow saturation is also small in the fifth to ninth embodiments. In the fourth embodiment, the structure that is not particularly specified is similar to the structure described in the first embodiment.

### Fifth Embodiment

Table 7 below shows the green peak wavelength (nm), the green half-width (nm), the red peak wavelength (nm), and the red half-width (10 nm, 15 nm, 20 nm, 40 nm, 60 nm, 80 nm, and 100 nm) in the fifth embodiment (Examples 5-1 to 5-8).

TABLE 7

| | Green | | Red | |
|---|---|---|---|---|
| | Peak | | Peak | |
| | wavelength | Half-width | wavelength | Half-width |
| | (nm) | (nm) | (nm) | (nm) |
| Example 5-1 | 530 | 58 | 615 | 10-100 |
| Example 5-2 | | | 620 | |
| Example 5-3 | | | 625 | |
| Example 5-4 | | | 630 | |
| Example 5-5 | | | 635 | |
| Example 5-6 | | | 640 | |
| Example 5-7 | | | 645 | |
| Example 5-8 | | | 650 | |

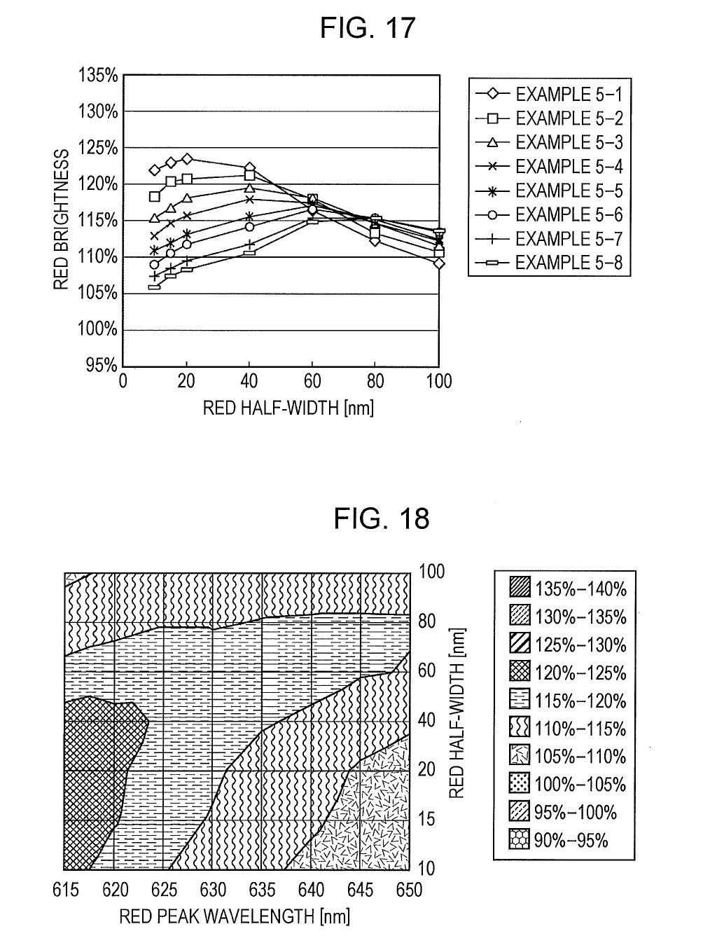

FIG. 17 is a graph showing the relationship between the red half-width (nm) and the red brightness (%) according to the fifth embodiment. FIG. 18 is a distribution chart of the red brightness (%) in which the vertical axis represents the red half-width (nm) and the horizontal axis represents the red peak wavelength (nm) according to the fifth embodiment. The structure of the fifth embodiment is similar to that of the fourth embodiment except that the green peak wavelength λp in the spectrum of the backlight light source is 530 nm instead of 535 nm.

### Sixth Embodiment

Table 8 below shows the green peak wavelength (nm), the green half-width (nm), the red peak wavelength (nm), and the red half-width (10 nm, 15 nm, 20 nm, 40 nm, 60 nm, 80 nm, and 100 nm) in the sixth embodiment (Examples 6-1 to 6-8).

TABLE 8

| | Green | | Red | |
|---|---|---|---|---|
| | Peak | | Peak | |
| | wavelength | Half-width | wavelength | Half-width |
| | (nm) | (nm) | (nm) | (nm) |
| Example 6-1 | 525 | 58 | 615 | 10-100 |
| Example 6-2 | | | 620 | |
| Example 6-3 | | | 625 | |
| Example 6-4 | | | 630 | |
| Example 6-5 | | | 635 | |
| Example 6-6 | | | 640 | |
| Example 6-7 | | | 645 | |
| Example 6-8 | | | 650 | |

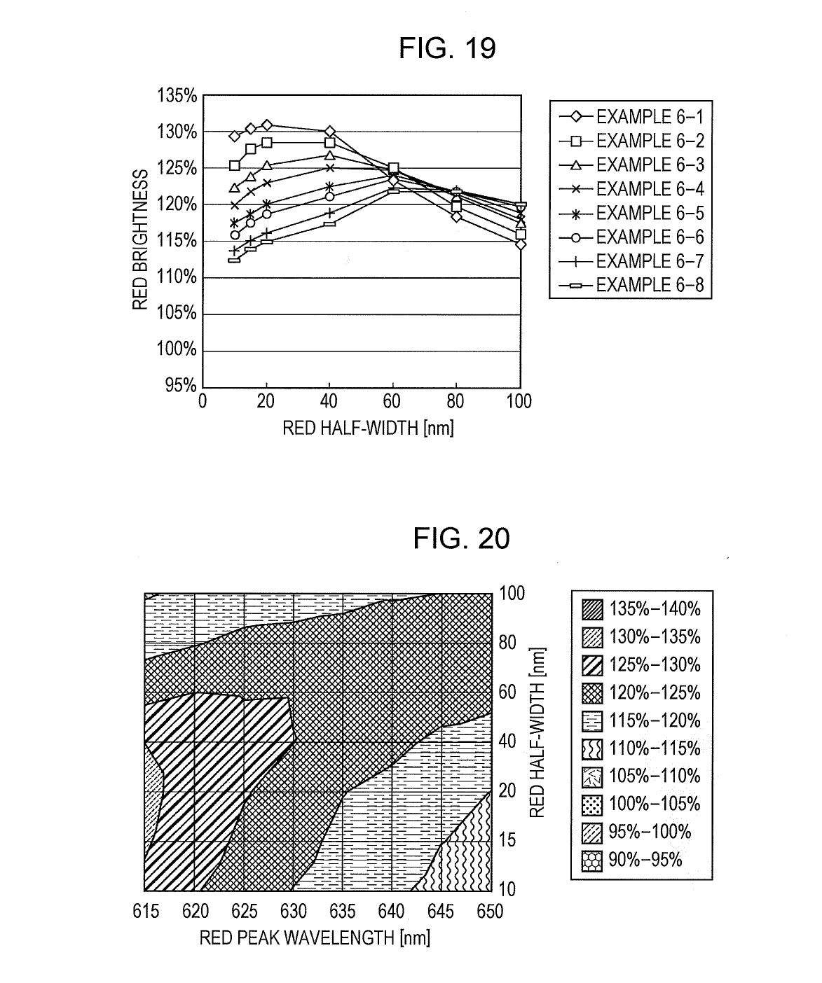

FIG. 19 is a graph showing the relationship between the red half-width (nm) and the red brightness (%) according to the sixth embodiment. FIG. 20 is a distribution chart of the red brightness (%) in which the vertical axis represents the red half-width (nm) and the horizontal axis represents the red peak wavelength (nm) according to the sixth embodiment.

The structure of the sixth embodiment is similar to that of the fourth embodiment except that the green peak wavelength λp in the spectrum of the backlight light source is 525 nm instead of 535 nm.

### Seventh Embodiment

Table 9 below shows the green peak wavelength (nm), the green half-width (nm), the red peak wavelength (nm), and the red half-width (10 nm, 15 nm, 20 nm, 40 nm, 60 nm, 80 nm, and 100 nm) in the seventh embodiment (Examples 7-1 to 7-8).

TABLE 9

| | Green | | Red | |
|---|---|---|---|---|
| | Peak | | Peak | |
| | wavelength | Half-width | wavelength | Half-width |
| | (nm) | (nm) | (nm) | (nm) |
| Example 7-1 | 535 | 48 | 615 | 10-100 |
| Example 7-2 | | | 620 | |
| Example 7-3 | | | 625 | |
| Example 7-4 | | | 630 | |
| Example 7-5 | | | 635 | |
| Example 7-6 | | | 640 | |
| Example 7-7 | | | 645 | |
| Example 7-8 | | | 650 | |

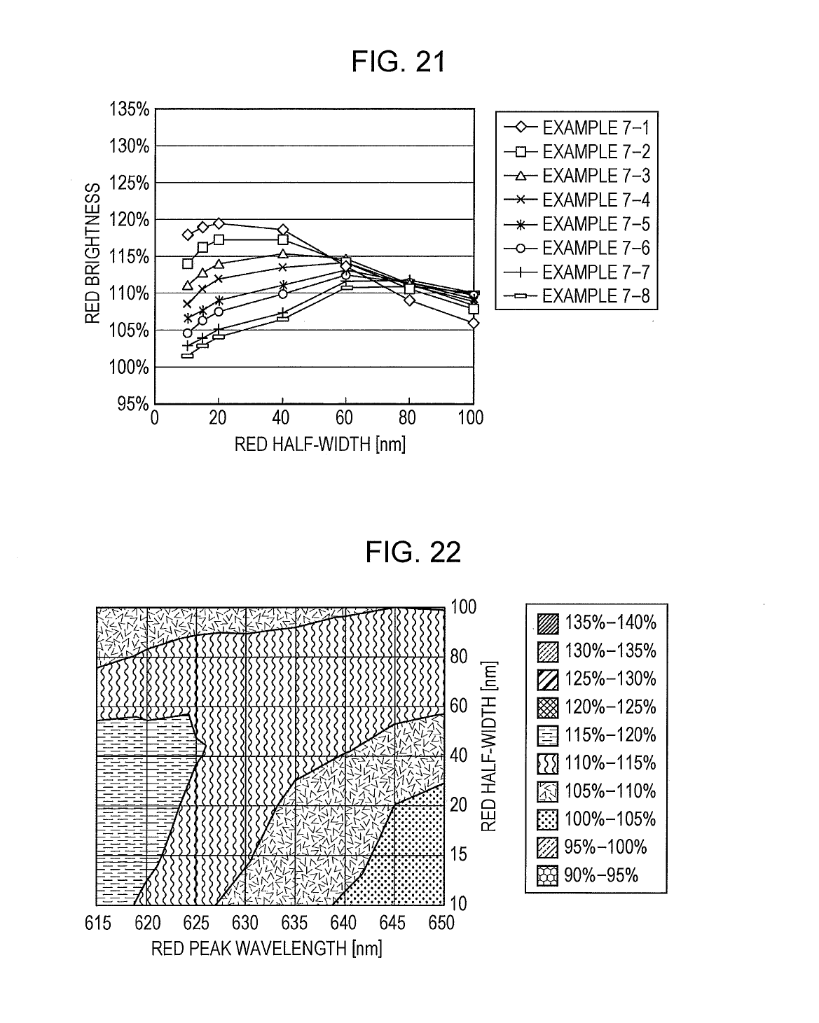

FIG. 21 is a graph showing the relationship between the red half-width (nm) and the red brightness (%) according to the seventh embodiment. FIG. 22 is a distribution chart of the red brightness (%) in which the vertical axis represents the red half-width (nm) and the horizontal axis represents the red peak wavelength (nm) according to the seventh embodiment.

The structure of the seventh embodiment is similar to that of the fourth embodiment except that the green half-width in the spectrum of the backlight light source is 48 nm instead of 58 nm.

### Eighth Embodiment

Table 10 below shows the green peak wavelength (nm), the green half-width (nm), the red peak wavelength (nm), and the red half-width (10 nm, 15 nm, 20 nm, 40 nm, 60 nm, 80 nm, and 100 nm) in the eighth embodiment (Examples 8-1 to 8-8).

TABLE 10

| | Green | | Red | |
|---|---|---|---|---|
| | Peak | | Peak | |
| | wavelength | Half-width | wavelength | Half-width |
| | (nm) | (nm) | (nm) | (nm) |
| Example 8-1 | 535 | 35 | 615 | 10-100 |
| Example 8-2 | | | 620 | |
| Example 8-3 | | | 625 | |
| Example 8-4 | | | 630 | |
| Example 8-5 | | | 635 | |
| Example 8-6 | | | 640 | |
| Example 8-7 | | | 645 | |
| Example 8-8 | | | 650 | |

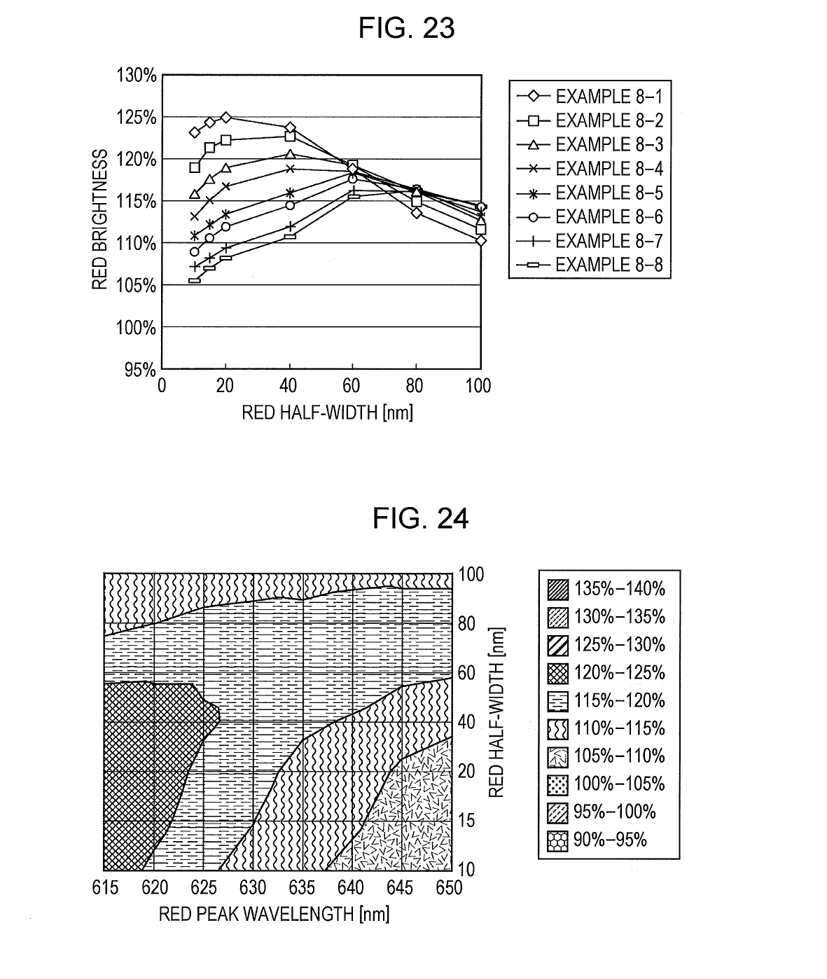

FIG. 23 is a graph showing the relationship between the red half-width (nm) and the red brightness (%) according to the eighth embodiment. FIG. 24 is a distribution chart of the red brightness (%) in which the vertical axis represents the red half-width (nm) and the horizontal axis represents the red peak wavelength (nm) according to the eighth embodiment.

The structure of the eighth embodiment is similar to that of the fourth embodiment except that the green half-width in the spectrum of the backlight light source is 35 nm instead of 58 nm.

The results of the above-described fourth to eighth embodiments show that, with regard to green (G) in Examples 1-1 to 1-3 (which is also green (G) in Examples 2-1 to 2-3 and green (G) in Examples 3-1 to 3-3), the red brightness can be greatly increased to 110% or more of that in the related art by appropriately setting the read (R) peak wavelength and half-width. It is particularly preferable to adjust the red (R) spectral shape together with the green (G) spectral shape so that the red brightness can be increased to 110% or more. For example, green (G) light emitted from the light source preferably has a green peak wavelength of 510 nm or more and 535 nm or less. Alternatively, the light emitted from the light source preferably has a green peak wavelength of 510 nm or more and 550 nm or less, which is a general wavelength range of green light, and a green half-width of 57 nm or less. In particular, the peak wavelength of green (G) light is preferably 525 nm or more. In addition, the peak wavelength of green (G) light is preferably 540 nm or less. In addition, the half-width of green (G) light is preferably 50 nm or less, and more preferably, 35 nm or less. With regard to red (R) light emitted from the light source, the red peak wavelength is preferably 615 nm or more and 650 nm or less, and the half-width of the red peak is preferably in the range of 10 nm to 100 nm. It is particularly preferable to combine the preferred spectral shape (peak wavelength range and half-width range) of green (G) light with the preferred spectral shape (peak wavelength range and half-width range) of red light according to the first display device of the present invention. A display device in which both the red spectral shape and the green spectral shape are adjusted is particularly preferable. With such a display device, the effects of the present invention can be significantly enhanced.

### Ninth Embodiment

Table 11 below shows the green peak wavelength (nm), the green half-width (nm), the red peak wavelength (nm), and the red half-width (10 nm, 15 nm, 20 nm, 40 nm, 60 nm, 80 nm, and 100 nm) in the ninth embodiment (Examples 9-1 to 9-8).

TABLE 11

| | Green | | Red | |
|---|---|---|---|---|
| | Peak | | Peak | |
| | wavelength | Half-width | wavelength | Half-width |
| | (nm) | (nm) | (nm) | (nm) |
| Example 9-1 | 540 | 58 | 615 | 10-100 |
| Example 9-2 | | | 620 | |
| Example 9-3 | | | 625 | |
| Example 9-4 | | | 630 | |
| Example 9-5 | | | 635 | |
| Example 9-6 | | | 640 | |
| Example 9-7 | | | 645 | |
| Example 9-8 | | | 650 | |

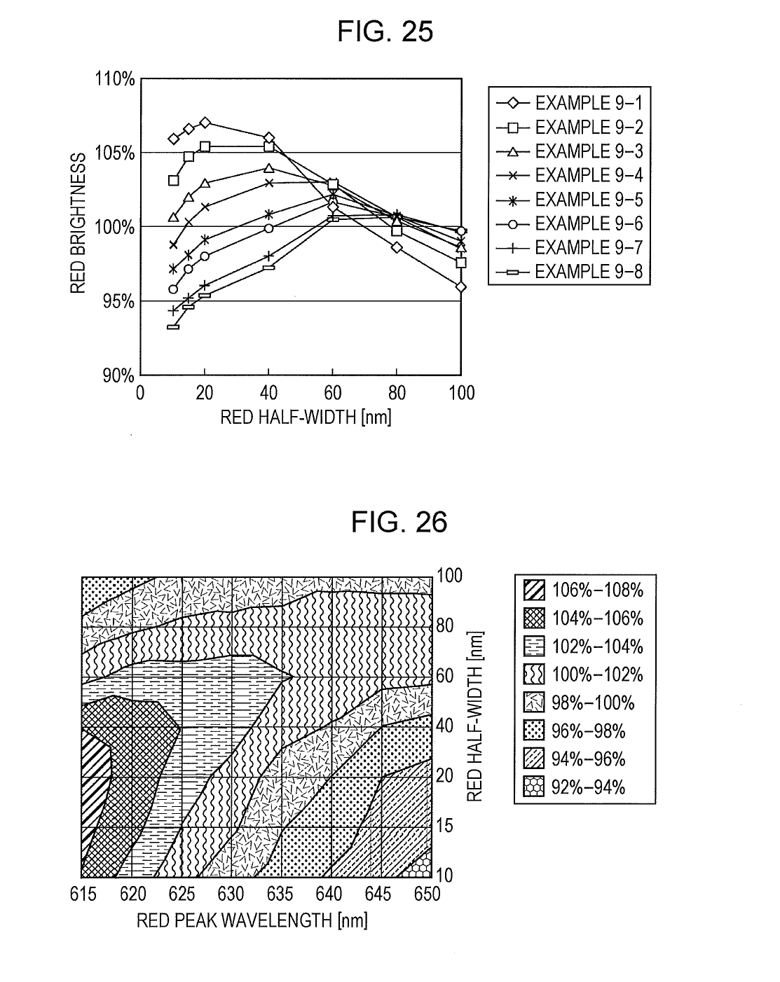

FIG. 25 is a graph showing the relationship between the red half-width (nm) and the red brightness (%) according to the ninth embodiment. FIG. 26 is a distribution chart of the red brightness (%) in which the vertical axis represents the red half-width (nm) and the horizontal axis represents the red peak wavelength (nm) according to the ninth embodiment.

The structure of the ninth embodiment is similar to that of the fourth embodiment except that the green peak wavelength λp in the spectrum of the backlight light source is 540 nm instead of 535 nm.

As is clear from FIGS. 25 and 26, even when the spectrum of green (G) light is not changed from that in the related art, the red brightness can be set to 100% or more of that in the related art by appropriately setting the red (R) peak wavelength and half-width.

As described above, the red brightness varies in accordance with the green (G) and red (R) spectral shapes of the backlight. The red brightness also varies in accordance with the opening ratio between the pixels and the set temperate of the white balance. The red brightness can be increased by increasing the opening ratio of the red pixels and reducing the color temperature of the white balance. In the above-described first to ninth embodiments, the effects obtained when the pixels have the same opening ratio and the color temperature of the white balance is 10000 K are explained. The effect of the first to ninth embodiments that the red brightness can be increased can be achieved also when the opening ratio and the color temperature of the white balance are set otherwise. The effect that the red brightness can be increased in the case where the opening ratio and the color temperature of the white balance are set to other values will now be described in detail in tenth to fourteenth embodiments.

### Tenth Embodiment

Table 12 below shows the green peak wavelength (nm), the green half-width (nm), the red peak wavelength (nm), and the red half-width (10 nm, 15 nm, 20 nm, 40 nm, 60 nm, 80 nm, and 100 nm) in the tenth embodiment (Examples 10-1 to 10-8).

TABLE 12

| | Green | | Red | |
|---|---|---|---|---|
| | Peak | | Peak | |
| | wavelength | Half-width | wavelength | Half-width |
| | (nm) | (nm) | (nm) | (nm) |
| Example 10-1 | 540 | 58 | 615 | 10-100 |
| Example 10-2 | | | 620 | |
| Example 10-3 | | | 625 | |
| Example 10-4 | | | 630 | |
| Example 10-5 | | | 635 | |
| Example 10-6 | | | 640 | |
| Example 10-7 | | | 645 | |
| Example 10-8 | | | 650 | |

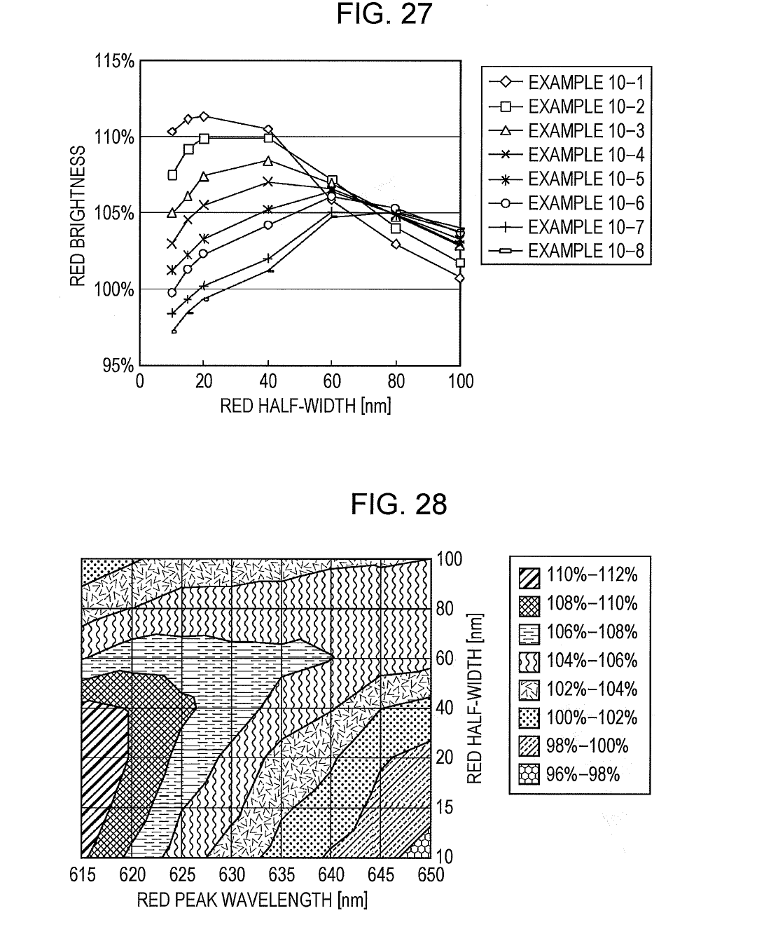

FIG. 27 is a graph showing the relationship between the red half-width (nm) and the red brightness (%) according to the tenth embodiment. FIG. 28 is a distribution chart of the red brightness (%) in which the vertical axis represents the red half-width (nm) and the horizontal axis represents the red peak wavelength (nm) according to the tenth embodiment.

The structure of the tenth embodiment is similar to the structure of the ninth embodiment except that the color temperature of white light emitted from the display surface is 9000 K (x=0.285, y=0.299) instead of 10000 K (x=0.278, y=0.291). The red (R) peak wavelength and half-width at which the red brightness can be increased are examined.

### Eleventh Embodiment

Table 13 below shows the green peak wavelength (nm), the green half-width (nm), the red peak wavelength (nm), and the red half-width (10 nm, 15 nm, 20 nm, 40 nm, 60 nm, 80 nm, and 100 nm) in the eleventh embodiment (Examples 11-1 to 11-8).

TABLE 13

| | Green | | Red | |
|---|---|---|---|---|
| | Peak | | Peak | |
| | wavelength | Half-width | wavelength | Half-width |
| | (nm) | (nm) | (nm) | (nm) |
| Example 11-1 | 540 | 58 | 615 | 10-100 |
| Example 11-2 | | | 620 | |
| Example 11-3 | | | 625 | |
| Example 11-4 | | | 630 | |
| Example 11-5 | | | 635 | |
| Example 11-6 | | | 640 | |
| Example 11-7 | | | 645 | |
| Example 11-8 | | | 650 | |

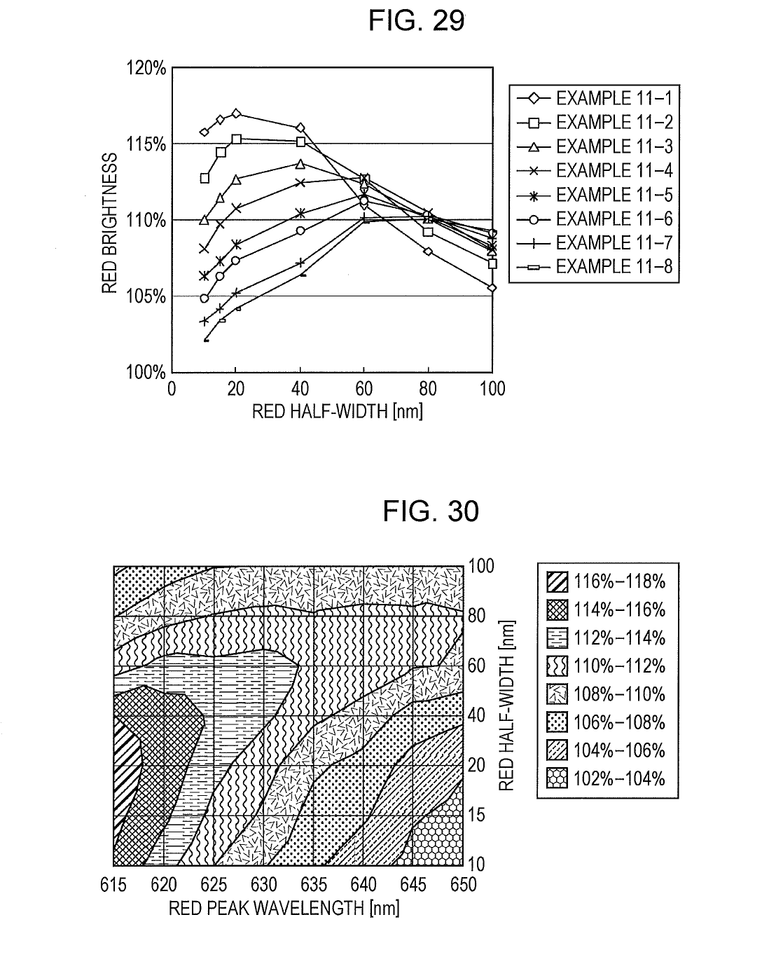

FIG. 29 is a graph showing the relationship between the red half-width (nm) and the red brightness (%) according to the eleventh embodiment. FIG. 30 is a distribution chart of the red brightness (%) in which the vertical axis represents the red half-width (nm) and the horizontal axis represents the red peak wavelength (nm) according to the eleventh embodiment.

The structure of the eleventh embodiment is similar to the structure of the ninth embodiment except that the color temperature of white light emitted from the display surface is 8000 K (x=0.294, y=0.309) instead of 10000 K (x=0.278, y=0.291). The red (R) peak wavelength and half-width at which the red brightness can be increased are examined.

### Twelfth Embodiment

Table 14 below shows the green peak wavelength (nm), the green half-width (nm), the red peak wavelength (nm), and the red half-width (10 nm, 15 nm, 20 nm, 40 nm, 60 nm, 80 nm, and 100 nm) in the twelfth embodiment (Examples 12-1 to 12-8).

TABLE 14

| | Green | | Red | |
|---|---|---|---|---|
| | Peak | | Peak | |
| | wavelength | Half-width | wavelength | Half-width |
| | (nm) | (nm) | (nm) | (nm) |
| Example 12-1 | 540 | 58 | 615 | 10-100 |
| Example 12-2 | | | 620 | |
| Example 12-3 | | | 625 | |
| Example 12-4 | | | 630 | |
| Example 12-5 | | | 635 | |
| Example 12-6 | | | 640 | |
| Example 12-7 | | | 645 | |
| Example 12-8 | | | 650 | |

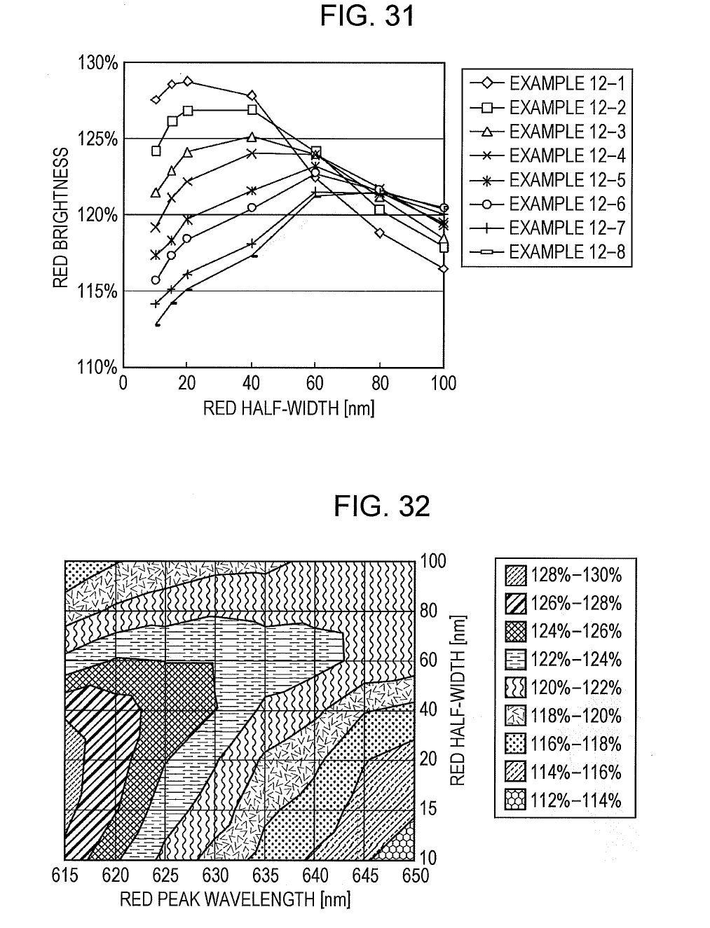

FIG. 31 is a graph showing the relationship between the red half-width (nm) and the red brightness (%) according to the twelfth embodiment. FIG. 32 is a distribution chart of the red brightness (%) in which the vertical axis represents the red half-width (nm) and the horizontal axis represents the red peak wavelength (nm) according to the twelfth embodiment.

The structure of the twelfth embodiment is similar to the structure of the ninth embodiment except that the color temperature of white light emitted from the display surface is 6500 K (x=0.313, y=0.329) instead of 10000 K (x=0.278, y=0.291). The red (R) peak wavelength and half-width at which the red brightness can be increased are examined.

### Thirteenth Embodiment

Table 15 below shows the green peak wavelength (nm), the green half-width (nm), the red peak wavelength (nm), and the red half-width (10 nm, 15 nm, 20 nm, 40 nm, 60 nm, 80 nm, and 100 nm) in the thirteenth embodiment (Examples 13-1 to 13-8).

TABLE 15

| | Green | | Red | |
|---|---|---|---|---|
| | Peak | | Peak | |
| | wavelength | Half-width | wavelength | Half-width |
| | (nm) | (nm) | (nm) | (nm) |
| Example 13-1 | 540 | 58 | 615 | 10-100 |
| Example 13-2 | | | 620 | |
| Example 13-3 | | | 625 | |
| Example 13-4 | | | 630 | |
| Example 13-5 | | | 635 | |
| Example 13-6 | | | 640 | |
| Example 13-7 | | | 645 | |
| Example 13-8 | | | 650 | |

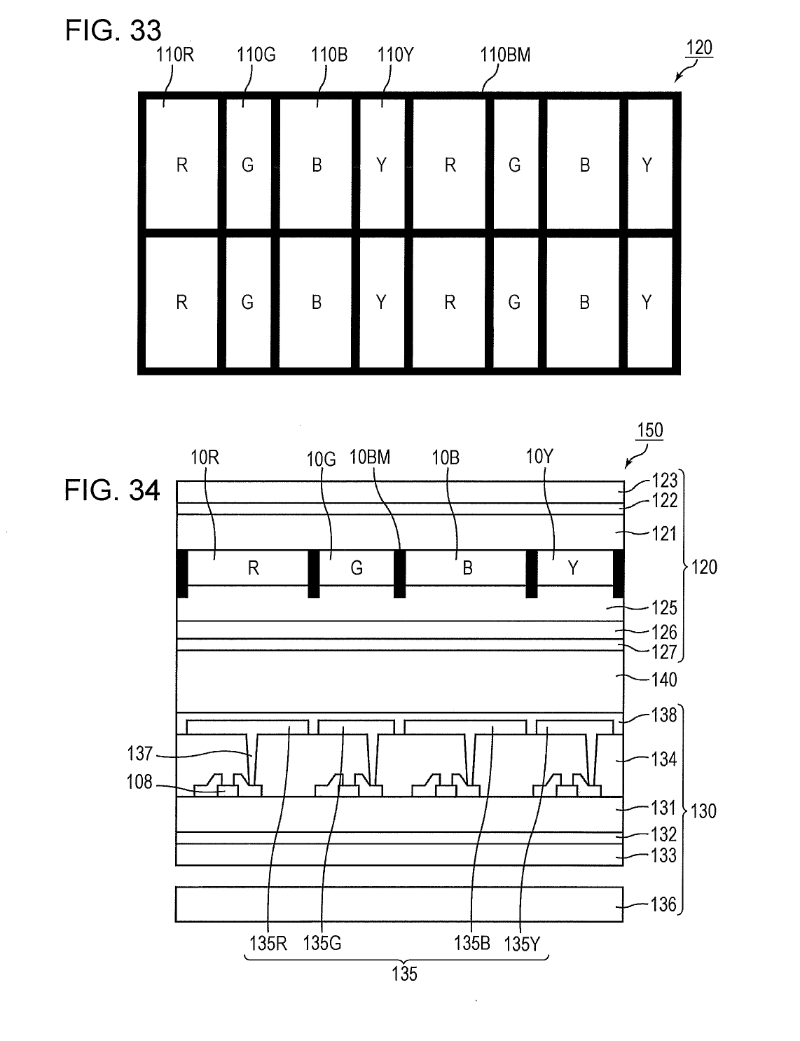

FIG. 33 is a schematic plan view of a counter substrate included in a liquid-crystal display device according to the thirteenth embodiment. FIG. 34 is a schematic sectional view of the liquid-crystal display device according to the thirteenth embodiment.

The structure of the thirteenth embodiment is similar to the structure of the ninth embodiment except that the opening ratio is set to R:G:B:Y=1.6:1:1.6:1 instead of R:G:B:Y=1:1:1:1. In FIGS. 33 and 34, components and parts having functions similar to those of the components and parts illustrated in FIGS. 2 and 3 are denoted by reference numerals obtained by adding 1 as the hundred's digit to the reference numerals in FIGS. 2 and 3.

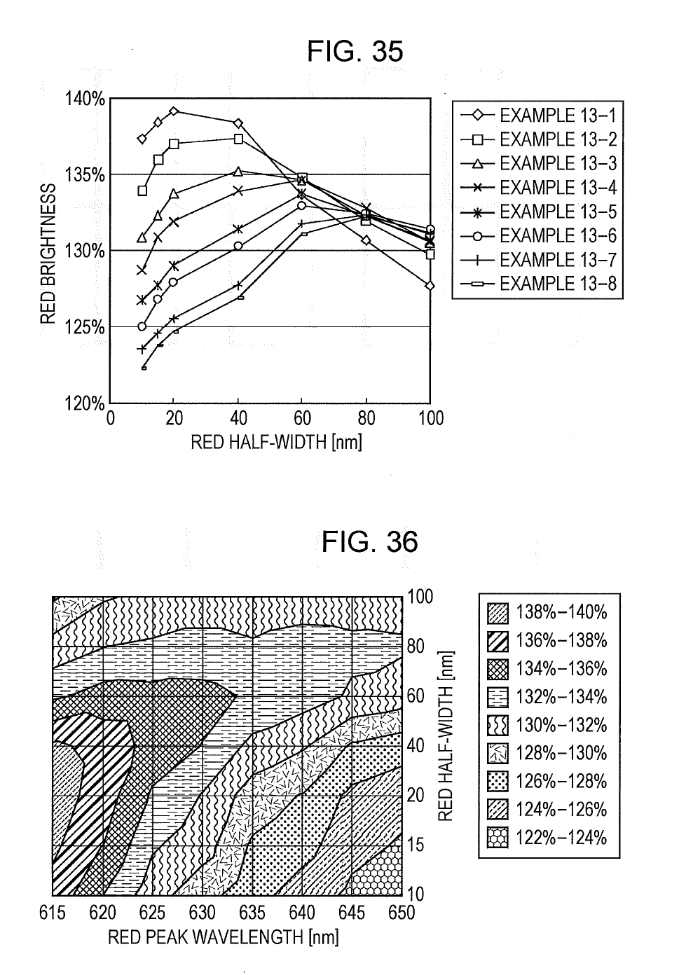

FIG. 35 is a graph showing the relationship between the red half-width (nm) and the red brightness (%) according to the thirteenth embodiment. FIG. 36 is a distribution chart of the red brightness (%) in which the vertical axis represents the red half-width (nm) and the horizontal axis represents the red peak wavelength (nm) according to the thirteenth embodiment.

In the thirteenth embodiment, the opening ratio is R:G:B:Y=1.6:1:1.6:1, and the color temperature of the white light emitted from the display surface is 10000 K (x=0.278, y=0.291). In addition, the green peak wavelength and half-width are 540 nm and 58 nm, respectively, as in the related art. In this case, the red (R) peak wavelength and half-width at which the red brightness can be increased are examined.

### Fourteenth Embodiment

Table 16 below shows the green peak wavelength (nm), the green half-width (nm), the red peak wavelength (nm), and the red half-width (10 nm, 15 nm, 20 nm, 40 nm, 60 nm, 80 nm, and 100 nm) in the fourteenth embodiment (Examples 14-1 to 14-8).

TABLE 16

| | Green | | Red | |
|---|---|---|---|---|
| | Peak | | Peak | |
| | wavelength | Half-width | wavelength | Half-width |
| | (nm) | (nm) | (nm) | (nm) |
| Example 14-1 | 540 | 58 | 615 | 10-100 |
| Example 14-2 | | | 620 | |
| Example 14-3 | | | 625 | |
| Example 14-4 | | | 630 | |
| Example 14-5 | | | 635 | |
| Example 14-6 | | | 640 | |
| Example 14-7 | | | 645 | |
| Example 14-8 | | | 650 | |

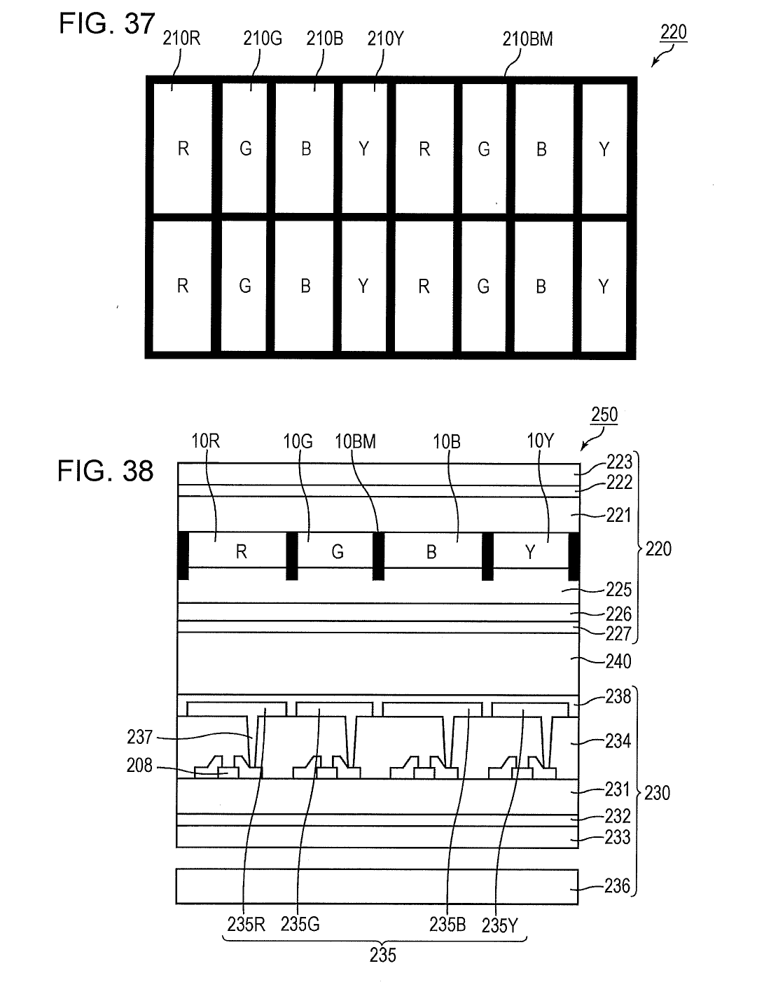

FIG. 37 is a schematic plan view of a counter substrate included in a liquid-crystal display device according to the fourteenth embodiment. FIG. 38 is a schematic sectional view of the liquid-crystal display device according to the fourteenth embodiment.

The structure of the fourteenth embodiments similar to the structure of the ninth embodiment except that the opening ratio is set to R:G:B:Y=1.3:1:1.3:1 instead of R:G:B:Y=1:1:1:1. In FIGS. 37 and 38, components and parts having functions similar to those of the components and parts illustrated in FIGS. 2 and 3 are denoted by reference numerals obtained by adding 2 as the hundred's digit to the reference numerals in FIGS. 2 and 3.

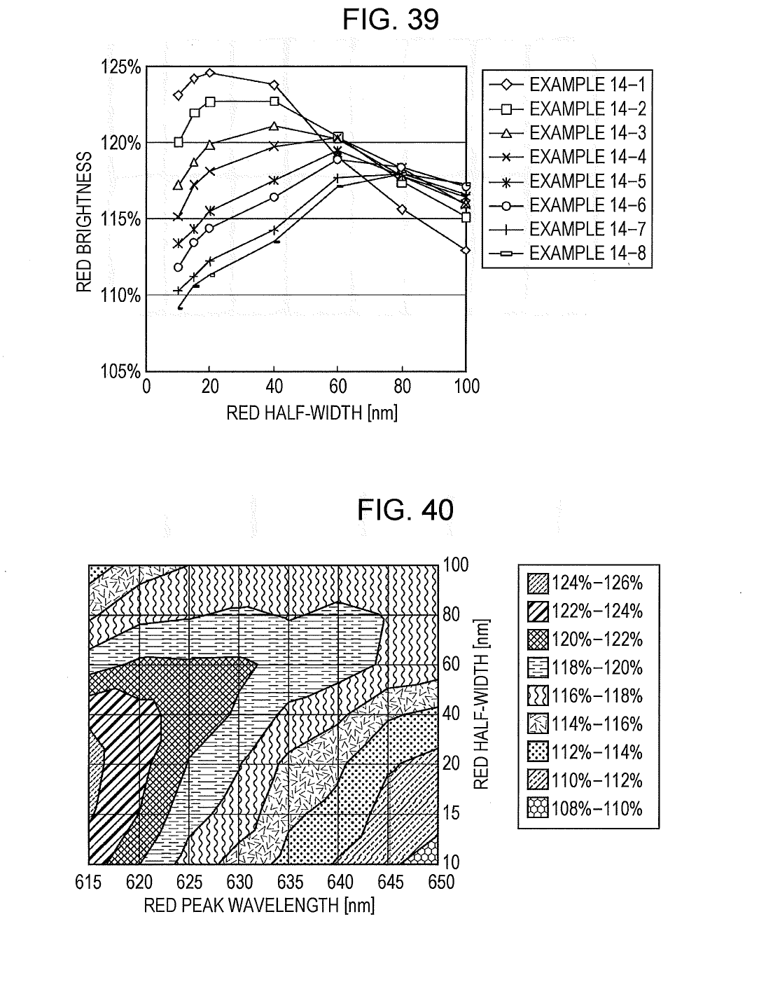

FIG. 39 is a graph showing the relationship between the red half-width (nm) and the red brightness (%) according to the fourteenth embodiment. FIG. 40 is a distribution chart of the red brightness (%) in which the vertical axis represents the red half-width (nm) and the horizontal axis represents the red peak wavelength (nm) according to the fourteenth embodiment.

In the fourteenth embodiment, the opening ratio is R:G:B:Y=1.3:1:1.3:1, and the color temperature of the white light is 10000 K (x=0.278, y=0.291). In addition, the green peak wavelength and half-width are 540 nm and 58 nm, respectively, as in the related art. In this case, the red (R) peak wavelength and half-width at which the red brightness can be increased are examined.

Even when the spectrum of green (G) light is not changed from that in the related art, the effects of the present invention, such as the effect that the red brightness can be set to 100% or more of that in the related art, can be achieved by appropriately setting the red (R) peak wavelength and half-width. For example, as described above, preferably, in a display device which forms an image by using red, green, blue, and yellow pixels and includes a light source, light emitted from the light source has a red peak wavelength of 615 nm or more and 650 nm or less, and a half-width of the red peak is 15 nm or more and 70 nm or less when the peak wavelength is 615 nm or more and 635 nm or less, 40 nm or more and 93 nm or less when the peak wavelength is more than 635 nm and 640 nm or less, and 57 nm or more and 93 nm or less when the peak wavelength is more than 640 nm and 650 nm or less. More preferably, in the display device, the half-width of the red peak is 15 nm or more when the peak wavelength is 615 nm or more and 625 nm or less and 30 nm or more when the peak wavelength is more than 625 nm and 635 nm or less. In this case, the red brightness can be further improved.

As is clear from the comparison between the ninth to twelfth embodiments, the red brightness can be increased as the color temperature of the white light emitted from the display surface is reduced. In addition, the red brightness can be increased as the opening ratio of the red and blue pixels is increased with respect to the opening ratio of the green and yellow pixels.

According to the ninth to fourteenth embodiments, the red brightness corresponding to the spectrum according to the related art (green (G) peak wavelength and half-width are 540 nm and 58 nm, respectively, and red (R) peak wavelength and half-width are 640 nm and 100 nm, respectively) is 100.0% (Example 9-6), •103.7% (Example 10-6), •109.1% (Example 11-6), •120.4% (Example 12-6), •131.4% (Example 13-6), and 117.1% (Example 14-6). The embodiments in which the red brightness is higher than these values provide the effects of the present invention.

### (Example of Spectrum of Backlight)

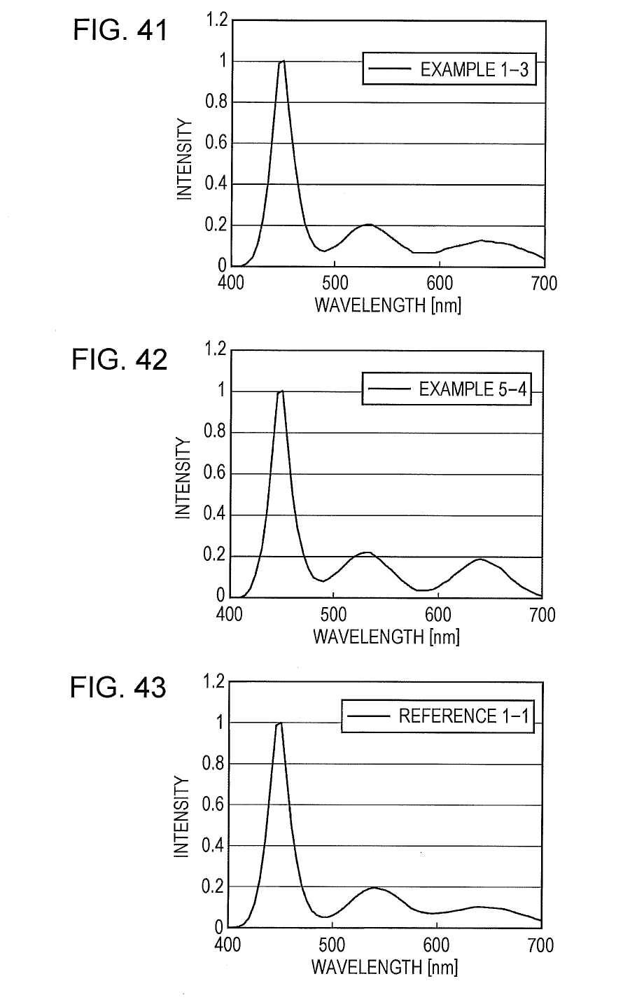

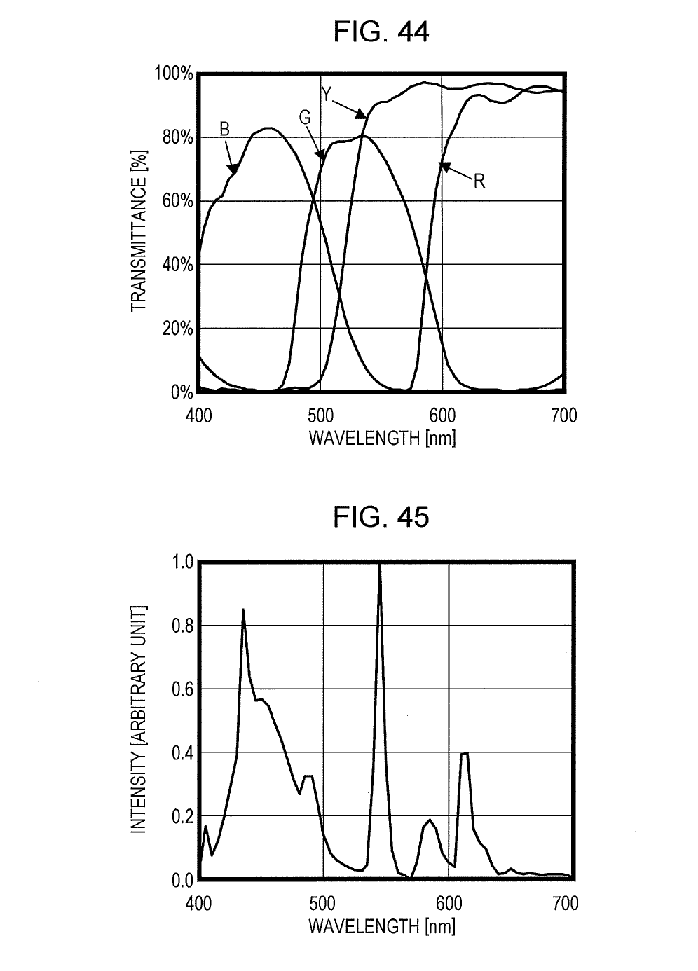

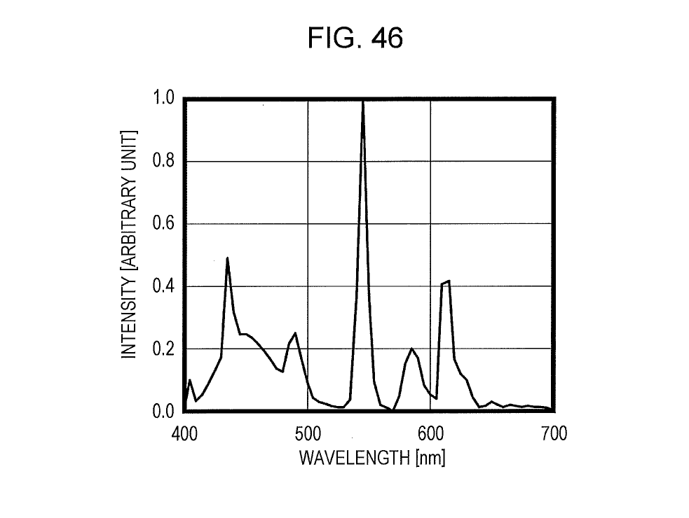

FIG. 41 is a graph showing the relationship between the wavelength (nm) and the intensity which shows the spectrum of the backlight used in Example 1-3.

The green (G) and red (R) spectral shapes are as follows.

Green (G): peak wavelength 530 nm, half-width 58 nm

Red (R): peak wavelength 640 nm, half-width 100 nm

FIG. 42 is a graph showing the relationship between the wavelength (nm) and the intensity which shows the spectrum of the backlight used in Example 5-4.

The green (G) and red (R) spectral shapes are as follows.

Green (G): peak wavelength 530 nm, half-width 58 nm

Red (R): peak wavelength 640 nm, half-width 58 nm

FIG. 43 is a graph showing the relationship between the wavelength (nm) and the intensity which shows the spectrum of the backlight used in Reference 1-1.

The green (G) and red (R) spectral shapes are as follows.

Green (G): peak wavelength 540 nm, half-width 58 nm

Red (R): peak wavelength 640 nm, half-width 100 nm

The three wavelengths at which the radiant intensity is at a maximum, second highest, and third highest in the spectrum of the backlight are basically included in three different ranges of, for example, 400 nm to 500 nm, 500 nm to 600 nm, and 600 nm to 700 nm, which correspond to, blue, green, and red. The blue peak wavelength is in the range of 440 nm to 460 nm, and the blue half-width is as small as possible. Preferably, the blue half-width is 30 nm or less.

As defined by CIE 1976, the blue and yellow saturations (C*) can be expressed as {(a*)²+(b*)²}0.5. Here, a* and b* represent directions of color in the chromaticity diagram, and correspond to the red direction and yellow direction, respectively. The display is satisfactory when the blue saturation is 25 or more and the yellow saturation is 40 or more.

### (Regarding Calculation Method)

A method for calculating the peak wavelength, etc., according to the present embodiment will now be described. Here, it is assumed that BL1(λ) and BL2(λ) are spectrums of the backlight. Details will now be described.

In this specification, it is assumed that the spectrum of the backlight is a combination of spectrums of light emitting elements having R, G, and B wavelength ranges, each spectrum having a Gaussian distribution centered on the peak wavelength.

The spectral transmittance characteristics of the liquid crystal layer that displays each color will be expressed as follows. That is, the spectral transmittance characteristics of white display of the liquid crystal layer is defined as LCDw(λ), and the spectral transmittance characteristics of black display of the liquid crystal layer is defined as LCDbk(λ). In addition, the spectral transmittance characteristics of the red color filter is defined as CFr(λ), the spectral transmittance characteristics of the green color filter as CFg(λ), the spectral transmittance characteristics of the blue color filter as CFb(λ), the spectral transmittance characteristics of the yellow color filter as CFy(λ), and the spectral transmittance characteristics of the cyan color filter as CFc(λ).

In addition, the opening ratio of the pixels of each color is expressed as follows. That is, the opening ratio of the red pixels is defined as Pr, the opening ratio of the green pixels as Pg, the opening ratio of the blue pixels as Pb, the opening ratio of the yellow pixels as Py, and the opening ratio of the cyan pixels as Pc. Here, Pr+Pg+Pb+Py+Pc=1 is satisfied, and Pc=0 when the display device has no cyan pixels.

The spectrum of white display of the display device can be obtained from the following Eq. 1 by using spectrum BL1(λ) of the backlight.

White(λ)={Pr·CFr(λ)·LCDw(λ)+Pg·CFg(λ)·LCDw(λ)+Pb·CFb(λ)·LCDw(λ)+Py·CFy(λ)·LCDw(λ)+Pc·CFc(λ)·LCDbk(λ)}×BL1(λ) (Eq. 1)

The chroma (xw, yw) of this white display can be determined as follows. That is, three tristimulus values Xw, Yw, and Zw of the white display are calculated from the wavelength characteristics of the white display White(λ) expressed in (Eq. 1) on the basis of the CIE color system. Then, the chroma (xw, yw) of the white display is determined by using Xw, Yw, and Zw.

When the thus-determined chroma (xw, yw) differs from a predetermined chroma, the peak heights in the R and G ranges of the backlight are adjusted so that the chroma of the white display becomes the same as the predetermined chroma. The spectrum of the backlight after the adjustment is defined as BL2(λ).

The spectrums of other display colors are calculated as in (Eq. 2) to (Eq. 6) by using the spectrum BL2(λ) of the backlight after the adjustment of the chroma of the white display.

Red(λ)={Pr·CFr(λ)·LCDw(λ)+Pg·CFg(λ)·LCDbk(λ)+Pb·CFb(λ)·LCDbk(λ)+Py·CFy(λ)·LCDbk(λ)+Pc·CFc(λ)·LCDbk(λ)}×BL2(λ) (Eq. 2)

Green(λ)={Pr·CFr(λ)·LCDbk(λ)+Pg·CFg(λ)·LCDw(λ)+Pb·CFb(λ)·LCDbk(λ)+Py·CFy(λ)·LCDbk(λ)+Pc·CFc(λ)·LCDbk(λ)}×BL2(λ) (Eq. 3)

Blue(λ)={Pr·CFr(λ)·LCDbk(λ)+Pg·CFg(λ)·LCDbk(λ)+Pb·CFb(λ)·LCDw(λ)+Py·CFy(λ)·LCDbk(λ)+Pc·CFc(λ)·LCDbk(λ)}×BL2(λ) (Eq. 4)

Yellow(λ)={Pr·CFr(λ)·LCDw(λ)+Pg·CFg(λ)·LCDw(λ)+Pb·CFb(λ)·LCDbk(λ)+Py·CFy(λ)·LCDw(λ)+Pc·CFc(λ)·LCDbk(λ)}×BL2(λ) (Eq. 5)

Cyan(λ)={Pr·CFr(λ)·LCDbk(λ)+Pg·CFg(λ)·LCDbk(λ)+Pb·CFb(λ)·LCDbk(λ)+Py·CFy(λ)·LCDbk(λ)+Pc·CFc(λ)·LCDw(λ)}×BL2(λ) (Eq. 6)

Similar to the above-described white display, the tristimulus values of each display color are calculated from the spectrum of that display color that is calculated as described above, and the chroma, brightness, and saturation are calculated on the basis of the CIE color system. The chroma coordinate x of red may be less than 0.64 depending on BL2(λ). In such a case, CFr(λ) is readjusted so that the chroma coordinate x of red is 0.64 or more.

In an LED type backlight, the green (G) peak wavelength and half-width are 530 nm and 32 nm, respectively. The red (R) peak wavelength and half-width are 630 nm and 17 nm, respectively. In a fluorescence type backlight that is currently used, the green (G) peak wavelength and half-width are 539 nm and 59 nm, respectively. The red (R) peak wavelength and half-width are 638 nm and 97 nm, respectively.

In practice, industrially manufactured backlights of both the LED type and fluorescence type have peak wavelengths and half-widths that differ by about ±3 nm due to individual differences.

In the first to fourteenth embodiments, a cold cathode fluorescent tube (CCFT, CCFL), a white light emitting diode (combination of a blue LED and yellow fluorescence), an RGB-LED, a hot cathode fluorescent tube (HCFT), an organic EL display, a field emission display (FED), etc., may be used as appropriate as a backlight light source.

In addition, in the first to fourteenth embodiments, transmissive liquid-crystal display devices that display images by using backlights are described. However, the present invention may be applied not only to transmissive liquid-crystal display devices but also to liquid-crystal display devices of other display methods, such as reflective-transmissive liquid-crystal display devices that perform a transmissive display operation by using a backlight and a reflective display operation by using external light and/or a front light and reflective liquid-crystal display devices that display images by using a light source such as a front light, and to various other display devices such as cathode-ray tubes (CRTs), organic electro-luminescence displays (OELDs), plasma display panels (PDPs), and field emission displays (FEDs) such as surface-conduction electron-emitter displays (SEDs). In the specification of the subject application, a range of a certain numerical value “or more” and a range of a certain numerical value “or less” include those numerical values (boundary values).

The above-described embodiments may be combined as appropriate within the scope of the present invention.

The present application claims priority to Japanese Patent Application No. 2011-127603 filed on Jun. 7, 2011 under the Paris Convention and provisions of national law in a designated State. The entire contents of the application are incorporated herein by reference.

### REFERENCE SIGNS LIST

3: auxiliary capacitor
4: scanning line
6: signal line
7: auxiliary capacitor (Cs) wire
8: thin-film transistor (TFT)
9: drain lead wire
10R, 110R, 210R: red color filter
10G, 110G, 210G: green color filter
10B, 110B, 210B: blue color filter
10Y, 110Y, 210Y: yellow color filter
10BM, 110BM, 210BM: black matrix (black portion)
20, 120, 220: color filter substrate (counter substrate)
21, 31, 121, 131, 221, 231: glass substrate
22, 32, 122, 132, 222, 232: retardation plate
23, 33, 123, 133, 223, 233: polarizing plate
25, 125, 225: overcoat layer
26, 126, 226: counter electrode
27, 38, 127, 138, 227, 238: alignment film
30, 130, 230: thin-film transistor (TFT) substrate
34, 134, 234: interlayer insulation film
35, 135, 235: transparent electrode
35R, 135R, 235R: red transparent electrode
35G, 135G, 235G: green transparent electrode
35B, 135B, 235B: blue transparent electrode
35Y, 135Y, 235Y: yellow transparent electrode
36, 136, 236: backlight
37, 137, 237: contact hole
40, 140, 240: liquid crystal layer
50, 150, 250: liquid-crystal display device

1. A display device that forms an image by using red, green, blue, and yellow pixels,
wherein the display device includes a light source,
wherein light emitted from the light source has a red peak wavelength of 615 nm or more and 650 nm or less, and
wherein a half-width of the red peak is 15 nm or more and 70 nm or less when the peak wavelength is 615 nm or more and 635 nm or less, 40 nm or more and 93 nm or less when the peak wavelength is more than 635 nm and 640 nm or less, and 57 nm or more and 93 nm or less when the peak wavelength is more than 640 nm and 650 nm or less.

2. The display device according to claim 1,
wherein the red peak wavelength is 635 nm or less.

3. A display device that forms an image by using red, green, blue, and yellow pixels,
wherein the display device includes a light source, and
wherein light emitted from the light source has a green peak wavelength of 510 nm or more and 535 nm or less.

4. The display device according to claim 3,
wherein the green peak wavelength is 520 nm or more.

5. A display device that forms an image by using red, green, blue, and yellow pixels,
wherein the display device includes a light source,
wherein light emitted from the light source has a green peak wavelength of 510 nm or more and 540 nm or less, and
wherein a half-width of the green peak is 57 nm or less.

6. The display device according to claim 5,
wherein the half-width of the green peak is 30 nm or more.

7. The display device according to claim 1,
wherein a pixel area ratio between colors of the display device is 1 or more and 1.6 or less.

8. The display device according to claim 1,
wherein the display device includes a color filter substrate in which at least a red color filter, a green color filter, a blue color filter, and a yellow color filter are arranged so as to correspond to the respective pixels.

9. The display device according to claim 1,
wherein the display device is a liquid-crystal display device.

10. The display device according to claim 1,
wherein a color temperature of white light emitted from a display surface is less than 12000 K.
